(19) United States
(12) Patent Application Publication
(10) Pub. No.: US 2025/0081971 A1
(43) Pub. Date: Mar. 13, 2025

(54) COMBINATION OF COPPER-BASED FUNGICIDE AND AZOLE FUNGICIDE

(71) Applicant: Adama Makhteshim Ltd., Beer Sheva (IL)

(72) Inventors: Arunagirinathan Manickam Adhimoolam, Chennai, Tamil Nadu (IN); Venkateswararao Yadagani, Hyderabad, Telangana (IN); V V Krishna vasu Juthiga, Secunderabad, Telangana (IN); Diana Poliak, Beer Sheva (IL)

(73) Assignee: Adama Makhteshim Ltd., Beer Sheva (IL)

(21) Appl. No.: 18/725,336

(22) PCT Filed: Dec. 30, 2022
(86) PCT No.: PCT/IB2022/062934

§ 371 Date: Jun. 28, 2024

(30) Foreign Application Priority Data
Dec. 31, 2021 (IN) 202111062238

(51) Int. Cl. A01N 59/20; A01N 25/04; A01N 43/653; A01P 3/00

(52) U.S. Cl. CPC A01N 59/20; A01N 25/04; A01N 43/653; A01P 3/00

(57) ABSTRACT

The present invention provides combinations and compositions comprising (1) copper-based fungicide, (2) azole fungicide and (3) compatibility agent, preferably wherein the compatibility agent is a compound (I) selected from the group consisting of thiourea-based compound, sodium thiosulfate, alkyl amine, thioamide-based compound and any combination thereof. The present invention also provides process of preparing and methods of using said combinations and compositions.

Throughout this application various publications are referenced. The disclosures of these documents in their entireties are hereby incorporated by reference into this application in order to more fully describe the state of the art to which this invention pertains.

### TECHNICAL FIELD

The present invention provides a composition comprising (1) copper-based fungicide, (2) azole fungicide and (3) compound (I) selected from the group consisting of thiourea-based compound, sodium thiosulfate, alkyl amine, thioamide-based compound and any combination thereof. The invention further relates to methods for preparing and using said composition.

### BACKGROUND

Copper-based fungicides are well-known but uses of copper-based fungicides are limited due to phytotoxicity to plant and toxicity to the user.

Combination of copper-based fungicide and azole fungicide are known as effective combinations in controlling different diseases in crop

It is known that in compositions comprising copper-based fungicide and azole fungicide, the amount of the azole fungicide in presence of copper-based fungicide is reduced and there is a need to find a method for preventing this phenomenon.

### SUMMARY OF THE INVENTION

The present invention provides a combination comprising (1) copper-based fungicide, (2) azole fungicide and (3) compatibility agent. In some embodiments, the compatibility agent is compound (I) selected from the group consisting of thiourea-based compound, sodium thiosulfate, alkyl amine, thioamide-based compound, and any combination thereof.

The present invention provides a composition comprising copper-based fungicide, azole fungicide and compatibility agent. In some embodiments, the compatibility agent is compound (I) selected from the group consisting of thiourea-based compound, sodium thiosulfate, alkyl amine, thioamide-based compound, and any combination thereof.

In some embodiments, compound (I) is selected from the group consisting of thiourea-based compound, hexamethylene tetra amine, sodium thiosulfate, ethylene diamine and any combination thereof.

In some embodiments, the composition comprising (1) copper-based fungicide, (2) azole fungicide, (3) water and (4) compound (I) selected from group consisting of thiourea-based compound, sodium thiosulfate, alkyl amine, thioamide-based compound and any combination thereof.

The present invention provides use of compound (I) selected from group consisting of thiourea-based compound, sodium thiosulfate, alkyl amine, thioamide-based compound and any combination thereof for formulating or preparing a composition comprises copper-based fungicide and azole fungicide.

The present invention provides use of compound (I) selected from group consisting of thiourea-based compound, sodium thiosulfate, alkyl amine, thioamide-based compound and any combination thereof for formulating or preparing a composition comprises copper-based fungicide, azole fungicide and water.

The present invention provides a process for formulating or producing a composition comprising a copper-based fungicide and azole fungicide, the process comprising the following steps: (a) preparing an aqueous composition of the copper-based fungicide and compound (I) selected from group consisting of thiourea-based compound, sodium thiosulfate, alkyl amine, thioamide-based compound and any combination thereof, (b) combining with an azole fungicide.

The present invention also provides a method for controlling fungicidal disease comprising applying an effective amount of any one of the herein described combination and/or composition and/or diluted composition to a plant, a locus thereof, propagation material thereof, or an area infested with the unwanted insects so as to thereby control the pathogen disease.

The present invention also provides compound (I) for use in reducing the rate and/or extent of reduction or for preventing the reduction of the amount of an azole fungicide in a composition comprising (1) copper-based fungicide and (2) azole fungicide, so that the rate and/or extent of reduction in the amount of the azole amount is lower than the rate and/or extent of reduction of the amount of the azole fungicide in the same composition without compound (I).

The present invention also provides a composition comprising (1) a copper-based fungicide, (2) an azole fungicide and (3) at least one compound (I), for maintaining at least 90% w/w of the amount of the azole fungicide which was used for formulating or preparing the composition.

### DETAILED DESCRIPTION

### 4.1 Definitions

Unless defined otherwise, all technical and scientific terms used herein have the meaning commonly understood by persons of ordinary skill in the art to which this subject matter pertains.

The term “a” or “an”, as used herein, includes the singular and the plural, unless specifically stated otherwise. Therefore, the terms “a,” “an,” or “at least one” can be used interchangeably in this application.

As used herein, the term “about” when used in connection with a numerical value includes ±10% from the indicated value. In addition, all ranges directed to the same component or property herein are inclusive of the endpoints, are independently combinable, and include all intermediate points and ranges. It is understood that where a parameter range is provided, all integers within that range, and tenths thereof, are also provided by the invention. For example, “30-45%” includes 30%, 30.1%, 30.2%, etc. up to 45%.

The term “crop”, as is used herein, include cereals such as wheat, barley, rye, oats, sorghum and millet, rice, cassava and maize, and crops that produce, for example, peanut, sugar beet, cotton, soya, oilseed rape, potato, tomato, peach and vegetables.

The term “part of a plant”, as is used herein, indicates a part of a plant including, but not limited to, pollen, ovule, leaf, root, flower, fruit, stem, bulb, corn, branch and seed.

The term “thiourea-based compound” refers to a compound having a structure represented by the formula:

R¹NH—C(═S)—NHR²
wherein,
   (i) R¹, R², are both H;
   (ii) R¹ is H and R² is alkyl or alkenyl or alkynyl or aryl or heterocyclic;
   (iii) R¹, R² are each, independently, alkyl, alkenyl or alkynyl;
   (iv) R¹, R² are each, independently, aryl, or heterocyclic;
   (v) R¹ is alkyl or alkenyl or alkynyl and R² is aryl or heterocyclic, or
   (vi) R¹ and R² can be taken together with the nitrogens to which they are attached to form a ring containing 2 to 4 atoms of carbon and optionally one additional atom of nitrogen, sulfur or oxygen, said ring may be saturated or unsaturated and optionally substituted with 1 to 4 substituents selected from the group consisting of C₁-C₂ alkyl, halogen, CN, NO₂ and C₁-C₂ alkoxy.

As used herein, “alkyl” may be optionally substituted and denotes a linear or branched or cyclic hydrocarbon group comprising n carbon atoms. Alkyl includes both branched and straight-chain saturated aliphatic hydrocarbon groups which may be optionally substituted. Alkyl includes C₁-Cₙ alkyl which is defined to include groups having 1, 2 . . . , n−1 or n carbons in a linear or branched arrangement, and specifically includes methyl, ethyl, propyl, butyl, pentyl, hexyl, heptyl, isopropyl, isobutyl, sec-butyl, tertiary butyl and so on. An embodiment can be C₁-C₁₈ alkyl, C₁-C₁₆ alkyl, C₁-C₁₂ alkyl, C₂-C₁₂ alkyl, C₃-C₁₂ alkyl, C₄-C₁₂ alkyl and so on. An embodiment can be C₁-C₈ alkyl, C₂-C₅ alkyl, C₃-C₈ alkyl, C₄-C₈ alkyl and so on. In some embodiments, the alkyl is C₁-C₁₈ alkyl. In some embodiments, the alkyl is C₁-C₁₆ alkyl. In some embodiments, the alkyl is C₁-C₁₄ alkyl. In some embodiments, the alkyl is C₁-C₁₀ alkyl. In some embodiments, the alkyl is C₁-C₄ alkyl.

“Alkoxy” represents an alkyl group as described above attached through an oxygen bridge.

As used herein, “alkenyl” may be optionally substituted and denotes a linear or branched or cyclic hydrocarbon group comprising n carbon atoms and at least one double bond. Alkenyl includes a non-aromatic hydrocarbon radical, straight or branched, and optionally substituted, containing at least 1 carbon to carbon double bond, and up to the maximum possible number of non-aromatic carbon-carbon double bonds may be present. Alkenyl includes C₂-Cₙ alkenyl which is defined to include groups having 1, 2 . . . , n−1 or n carbons. For example, “C₂-C₆ alkenyl” means an alkenyl radical having 2, 3, 4, 5, or 6 carbon atoms, and at least 1 carbon-carbon double bond, and up to, for example, 3 carbon-carbon double bonds in the case of a C6 alkenyl, respectively. Alkenyl groups include ethenyl, propenyl, butenyl and cyclohexenyl. As described above with respect to alkyl, the straight, branched or cyclic portion of the alkenyl group may contain double bonds and may be substituted if a substituted alkenyl group is indicated. An embodiment can be C₂-C₁₂ alkenyl or C₂-C₅ alkenyl. In some embodiments, the alkenyl is C₁-C₁₈ alkenyl. In some embodiments, the alkenyl is C₁-C₁₆ alkenyl. In some embodiments, the alkenyl is C₁-C₁₄ alkenyl. In some embodiments, the alkenyl is C₁-C₁₀ alkenyl. In some embodiments, the alkenyl is C₁-C₄ alkenyl.

As used herein, “alkynyl” may be optionally substituted and denotes a linear or branched hydrocarbon group comprising n carbon atoms and at least one triple bond. Alkynyl includes a hydrocarbon radical, straight or branched, and optionally substituted, containing at least 1 carbon to carbon triple bond, and up to the maximum possible number of non-aromatic carbon-carbon triple bonds may be present. Alkynyl includes C₂-Cₙ alkynyl which is defined to include groups having 1, 2 . . . , n−1 or n carbons. For example, “C₂-C₆ alkynyl” means an alkynyl radical having 2 or 3 carbon atoms, and 1 carbon-carbon triple bond, or having 4 or 5 carbon atoms, and up to 2 carbon-carbon triple bonds, or having 6 carbon atoms, and up to 3 carbon-carbon triple bonds. Alkynyl groups include ethynyl, propynyl and butynyl. As described above with respect to alkyl, the straight or branched portion of the alkynyl group may contain triple bonds and may be substituted if a substituted alkynyl group is indicated. An embodiment can be a C₂-Cₙ alkynyl. An embodiment can be C₂-C₁₂ alkynyl or C₃-C₈ alkynyl. In some embodiments, the alkynyl is C₁-C₁₈ alkynyl. In some embodiments, the alkynyl is C₁-C₁₆ alkynyl. In some embodiments, the alkynyl is C₁-C₁₄ alkynyl. In some embodiments, the alkynyl is C₁-C₁₀ alkynyl. In some embodiments, the alkynyl is C₁-C₄ alkynyl.

As used herein, “aryl” may be optionally substituted and denotes to carbocyclic aromatic radicals having from 6 to 14 carbon atoms. Aryl includes any stable monocyclic, bicyclic or polycyclic carbon ring of up to 14 atoms in each ring, wherein at least one ring is aromatic, and may be unsubstituted or substituted. Examples of such aryl elements include but are not limited to: phenyl, p-toluenyl (4-methylphenyl), naphthyl, tetrahydro-naphthyl, indanyl, phenanthryl, anthryl or acenaphthyl. In cases where the aryl substituent is bicyclic and one ring is non-aromatic, it is understood that attachment is via the aromatic ring. In some embodiments, the aryl is a C₆-C₁₄ aryl.

As used herein, “heterocyclic” may be optionally substituted and denotes saturated, partially saturated or fully unsaturated cyclic radical which contains heteroatom(s). Preferably, the heterocyclic contains 3 to 6 ring atoms, of which 1 to 4 are from the group consisting of oxygen, nitrogen and sulfur. Heterocyclic includes a mono- or poly-cyclic ring system which can be saturated or contains one or more degrees of unsaturation and contains one or more heteroatoms. Preferred heteroatoms include N, O, and/or S, including N-oxides, sulfur oxides, and dioxides. Preferably the ring is three to ten-membered and is either saturated or has one or more degrees of unsaturation. The heterocycle may be unsubstituted or substituted, with multiple degrees of substitution being allowed. Such rings may be optionally fused to one or more of another “heterocyclic” ring(s), heteroaryl ring(s), aryl ring(s), or cycloalkyl ring(s). Examples of heterocycles include, but are not limited to, tetrahydrofuran, pyran, 1,4-dioxane, 1,3-dioxane, piperidine, piperazine, pyrrolidine, morpholine, thiomorpholine, tetrahydrothiopyran, tetrahydrothiophene, 1,3-oxathiolane, and the like.

In some embodiments, the thiourea-based compound is thiourea with the formula SC(NH₂)₂ and the structure H₂N—C(═S)—NH₂, (a.k.a. thiourea material).

Adding compound (I) selected from the group consisting of thiourea-based compound, alkyl amines including though not limited to hexamethylene tetra amine and ethylene diamine, sodium thiosulfate, thioamide-based compounds and any combination thereof to a composition which comprises copper-based fungicide and azole fungicide, can prevent and/or lower the rate and/or extent of reduction of the amount of the free azole fungicide in the composition [active content]. The amount of free azole fungicide in the composition may be detected by HPLC at same RT as the azole fungicide used to formulate the composition. The compared amount of azole fungicide in the inventive compositions is an amount calculated when measured by a method such as HPLC analysis of the peak area at the retention time associated with the free azole compound (azole fungicide that is used for formulating or preparing the composition), compared to comparable compositions comprising the copper-based fungicide and the azole fungicide, formulated in the absence of the compound (I). The term “Compound (I)” can alternatively be referred to as “compatibility agent” without departing from the invention by any degree, “compound (I)” is used simply for convenience.

The free azole fungicide or active content of azole fungicide is the form of azole fungicide used to formulate the composition. The amount of the azole fungicide used to formulate the composition serves as the reference point for calculating the percentage w/w of the free azole fungicide or active content of azole fungicide in the composition.

### Combination

The present invention provides a combination comprising (1) copper-based fungicide, (2) azole fungicide and (3) compatibility agent.

In some embodiment, the compatibility agent is a compound that increases the fungicidal efficacy of a composition comprising copper-based fungicide and azole fungicide compared to the same composition without the compatibility agent.

In some embodiments, the composition comprises an amount of compatibility agent such that the composition is more effective for controlling fungi compared to a composition prepared using the same copper-based fungicide and azole fungicide in the same amount but without the compatibility agent.

In some embodiments, the amount of the compatibility agent is effective for reducing the rate and/or extent of reduction or for preventing the reduction of the amount of azole fungicide in the composition. In some embodiments, the amount of azole fungicide in the composition is measured by HPLC. HPLC measurements may be taken using any one of the methods described throughout this application.

In some embodiments, the amount of the compatibility agent is effective for maintaining the amount of azole fungicide in the composition at an amount that is 80-99% of the amount of the azole fungicide used for formulating or preparing the composition. In some embodiments, the amount of the compatibility agent is effective for maintaining the amount of azole fungicide in the composition at an amount that is 85-99% of the amount of the azole fungicide used for formulating or preparing the composition. In some embodiments, the amount of the compatibility agent is effective for maintaining the amount of azole fungicide in the composition at an amount that is 90-99% of the amount of the azole fungicide used for formulating or preparing the composition. In some embodiments, the amount of the compatibility agent is effective for maintaining the amount of azole fungicide in the composition at an amount that is 95-99% of the amount of the azole fungicide used for formulating or preparing the composition. The amount of azole fungicide in the composition may be detected by HPLC at same RT as the azole used to formulate the composition.

In some embodiments, the compatibility agent is compound (I) selected from the group consisting of thiourea-based compound, sodium thiosulfate, alkyl amine, thioamide-based compound, and any combination thereof.

The present invention provides a combination comprising (1) copper-based fungicide, (2) azole fungicide and (3) compound (I) selected from the group consisting of thiourea-based compound, sodium thiosulfate, alkyl amine, thioamide-based compound, and any combination thereof.

In some embodiments, compound (I) is selected from the group consisting of thiourea-based compound, hexamethylene tetra amine, sodium thiosulfate, ethylene diamine, thioamide and any combination thereof.

In some embodiments, the alkyl amine is hexamethylene tetra amine, ethylene diamine, or a combination thereof.

In some embodiments, the compound (I) is mixed with the copper-based fungicide prior to combining with the azole fungicide.

In some embodiments, the compound (I) selected from the group consisting of thiourea-based compound, hexamethylene tetra amine, sodium thiosulfate, ethylene diamine and any combination thereof, is mixed with the copper-based fungicide prior to combing with the azole fungicide.

In some embodiments, the combination comprises water.

In some embodiments, the combination is a composition comprising (1) copper-based fungicide, (2) azole fungicide, (3) water and (4) the compound (I).

In some embodiments, the combination is a composition comprising (1) copper-based fungicide, (2) azole fungicide, (3) water and (4) compound (I) selected from group consisting of thiourea-based compound, sodium thiosulfate, alkyl amine, thioamide-based compound and any combination thereof.

In some embodiments, the combination is a composition comprising (1) copper-based fungicide, (2) azole fungicide, (3) water and (4) compound (I) selected from group consisting of thiourea-based compound, sodium thiosulfate, alkyl amine, thioamide-based compound and any combination thereof.

In some embodiments, the combination is a composition comprising (1) an amount of copper-based fungicide, (2) an amount of azole fungicide, (3) water and (4) an amount of compound (I) selected from group consisting of thiourea-based compound, sodium thiosulfate, alkyl amine, thioamide-based compound and any combination thereof.

In some embodiments, the combination is a composition comprising (1) copper-based fungicide, (2) azole fungicide, (3) water and (4) compound (I) selected from group consisting of thiourea-based compound, hexamethylene tetra amine, sodium thiosulfate, ethylene diamine and any combination thereof.

### Composition

The present invention provides a composition comprising (1) copper-based fungicide, (2) azole fungicide and (3) compatibility agent.

In some embodiments, the compatibility agent is compound (I) selected from the group consisting of thiourea-based compound, sodium thiosulfate, alkyl amine, thioamide-based compound, and any combination thereof.

In some embodiments, the composition comprises water.

In some embodiments, the composition further comprises at least one agriculturally acceptable additive.

In some embodiments, the composition comprises an amount of the azole fungicide that is at least 80% w/w of the amount of azole fungicide used for formulating or preparing the composition. In some embodiments, the composition comprises an amount of the azole fungicide that is at least 90% w/w of the amount of azole fungicide used for formulating or preparing the composition. In some embodiments, the composition comprises at least 90% w/w of the amount of the azole fungicide which was used for formulating or preparing the composition.

The amount of free azole fungicide in the composition may be detected by HPLC at same RT as the azole used to formulate the composition.

In some embodiments, the percentage w/w of the amount of the azole fungicide in the composition is measured by a HPLC analysis of the peak area at the retention time associated with the free azole compound.

In some embodiments, the composition has a percent active content of azole fungicide as measured by HPLC analysis of the peak area at the retention time associated with the free azole compound, in the composition which is greater than the active content of azole fungicide as measured by HPLC in a composition comprising the same amounts of the same copper-based fungicide and the same azole fungicide without compound (I).

In some embodiments, the composition has a percent active content of azole fungicide as measured by HPLC analysis of the peak area at the retention time associated with the free azole compound, in the composition which is greater than the active content of azole fungicide as measured by HPLC in a composition comprising the same amounts of the same copper-based fungicide and the same azole fungicide without compound (I). In some embodiments, the composition comprises at least 80% of the amount of the azole fungicide which was used for formulating or preparing the composition. In some embodiments, the composition comprises at least 85% of the amount of the azole fungicide which was used for formulating or preparing the composition. In some embodiments, the composition comprises 80-99% of the amount of the azole fungicide which was used for formulating or preparing the composition. In some embodiments, the composition comprises 85-99% of the amount of the azole fungicide which was used for formulating or preparing the composition. In some embodiments, the composition comprises 90-99% of the amount of the azole fungicide which was used for formulating or preparing the composition. In some embodiments, the composition comprises 95-99% of the amount of the azole fungicide which was used for formulating or preparing the composition.

In some embodiments, the composition comprises at least 80% w/w of the amount of the azole fungicide which was used for formulating or preparing the composition. In some embodiments, the composition comprises at least 85% w/w of the amount of the azole fungicide which was used for formulating or preparing the composition. In some embodiments, the composition comprises 80-99% w/w of the amount of the azole fungicide which was used for formulating or preparing the composition. In some embodiments, the composition comprises 85-99% w/w of the amount of the azole fungicide which was used for formulating or preparing the composition. In some embodiments, the composition comprises 90-99% w/w of the amount of the azole fungicide which was used for formulating or preparing the composition. In some embodiments, the composition comprises 95-99% w/w of the amount of the azole fungicide which was used for formulating or preparing the composition. The amount of free azole fungicide in the composition may be detected by HPLC at same RT as the azole used to formulate the composition.

In some embodiments, the composition comprises an amount of the azole fungicide that is at least 80% w/w of the azole fungicide which was used for formulating or preparing the composition. In some embodiments, the composition comprises an amount of the azole fungicide that is at least 85% w/w of the azole fungicide which was used for formulating or preparing the composition. In some embodiments, the composition comprises an amount of the azole fungicide that is 80-99% w/w of the azole fungicide which was used for formulating or preparing the composition. In some embodiments, the composition comprises an amount of the azole fungicide that is 85-99% w/w of the azole fungicide which was used for formulating or preparing the composition. In some embodiments, the composition comprises an amount of the azole fungicide that is 90-99% w/w of the azole fungicide which was used for formulating or preparing the composition. In some embodiments, the composition comprises an amount of the azole fungicide that is 95-99% w/w of the azole fungicide which was used for formulating or preparing the composition.

In some embodiments, the amount of azole fungicide in the composition is measured by HPLC. HPLC measurements may be taken using any one of the methods described throughout this application. The amount of azole fungicide in the composition may be detected by HPLC at same RT as the azole used to formulate the composition.

In some embodiments, the present invention provides a composition comprising (1) copper-based fungicide, (2) azole fungicide, (3) compound (I) and (4) water.

In some embodiments, the present invention provides a composition comprising (1) copper-based fungicide, (2) azole fungicide, (3) compound (I), (4) water and (5) at least one agriculturally acceptable additive.

In some embodiments, the invention also provides a composition comprising (1) copper-based fungicide, (2) azole fungicide, (3) compound (I) selected from group consisting of thiourea-based compound, sodium thiosulfate, alkyl amine, thioamide-based compound, and any combination thereof, (4) water and (5) at least one agriculturally acceptable additive.

In some embodiments, the present invention also provides a composition comprising (1) an amount of copper-based fungicide, (2) an amount of azole fungicide, (3) an amount of compound (I) selected from group consisting of thiourea-based compound, sodium thiosulfate, alkyl amine, thioamide-based compound and any combination thereof, (4) water and (5) at least one agriculturally acceptable additive.

In some embodiments, the invention also provides a composition comprising (1) copper-based fungicide, (2) azole fungicide, (3) compound (I) selected from group consisting of thiourea-based compound, hexamethylene tetra amine, sodium thiosulfate, ethylene diamine and any combination thereof, (4) water and (5) at least one agriculturally acceptable additive.

In some embodiments, the combination is a composition comprising (1) an amount of copper-based fungicide, (2) an amount of azole fungicide, (3) water and (4) an amount of compound (I) selected from group consisting of thiourea-based compound, hexamethylene tetra amine, sodium thiosulfate, ethylene diamine and any combination thereof.

In some embodiments, the present invention also provides a composition comprising (1) an amount of copper-based fungicide, (2) an amount of azole fungicide, (3) an amount of compound (I) selected from group consisting of thiourea-based compound, hexamethylene tetra amine, sodium thiosulfate, ethylene diamine and any combination thereof, (4) water and (5) at least one agriculturally acceptable additive.

In some embodiments, the composition comprises (1) copper-based fungicide, (2) azole fungicide and (3) compound (I), wherein compound (I) is thiourea.

In some embodiments, the composition comprises (1) copper-based fungicide, (2) azole fungicide and (3) compound (I), wherein compound (I) is ethylene diamine.

In some embodiments, the composition comprises (1) copper-based fungicide, (2) azole fungicide and (3) compound (I), wherein compound (I) is a mixture of sodium thiosulfate and thiourea.

The present invention also provides a composition comprising,
(1) at least one copper-based fungicide, (2) azole fungicide and (3) compound (I) wherein the composition comprises at least 90% of the amount of the azole fungicide which was used for formulating or preparing the composition.

The present invention also provides a composition comprising,
(1) at least one copper-based fungicide, (2) azole fungicide and (3) compound (I) wherein the composition comprises at least 95% of the amount of the azole fungicide which was used for formulating or preparing the composition.

The present invention also provides a composition comprising, (1) a copper-based fungicide, (2) an azole fungicide and (3) a compound (I)
wherein the composition has an active content of azole fungicide as measured by a method such as by HPLC analysis in the composition greater than the active content of azole fungicide measured by a method such as HPLC in a composition comprising the same amount of the same azole fungicide which is free of compound (I).

In some embodiments, active content refers to percentage by analysis of the free azole in a composition by % w/w compared to the amount used in formulating or preparing the composition.

The present invention also provides a composition comprising (1) a copper-based fungicide and (2) azole fungicide wherein the amount of free azole fungicide in the composition which further comprises compound (I) is higher compared to the amount of the free azole fungicide in the composition which is free of compound (I), when the amount of the azole fungicide is used for formulating or preparing the compositions is the same.

The present invention also provides a composition comprising (1) an amount of copper-based fungicide and (2) an amount of azole fungicide and (3) amount of compound (I), wherein the amount of azole fungicide in the composition is higher compared to composition comprises (1) an amount of copper-based fungicide and (2) an amount of azole fungicide and without compound (I) and when the same amount of the azole fungicide is used for formulating or preparing the compositions.

In some embodiments, the amount of the free azole fungicide in composition comprises copper-based fungicide, azole fungicide and compound (I) selected from group consisting of thiourea-based compound, sodium thiosulfate, alkyl amine, thioamide-based compound, and any combination thereof, is higher than when the composition comprises copper-based fungicide and azole fungicide without compound (I).

In some embodiments, the amount of the azole fungicide in composition comprises copper-based fungicide, azole fungicide and compound (I) selected from the group consisting of thiourea-based compound, hexamethylene tetra amine, sodium thiosulfate, ethylene diamine and any combination thereof, is higher than when the composition comprises copper-based fungicide and azole fungicide without compound (I).

In some embodiments, the reduction of the amount of azole fungicide in a composition, comprises copper-based fungicide, azole fungicide and compound (I) is less compared to the reduction of the amount of azole fungicide in a composition, comprises copper based fungicide, azole fungicide without compound (I).

In some embodiments, the amount and/or concentration of the active content of azole fungicide in the composition is measured by HPLC comparison of peak areas at the same retention time associated with the active azole compound used for formulating or preparing the composition. Active content of azole fungicide is free azole fungicide content.

In some embodiments, the compound (I) is mixed with the copper-based fungicide prior to the combing with the azole fungicide.

In some embodiments, the composition comprises additional fungicide(s).

In some embodiments, the composition further comprises water-immiscible carrier.

In some embodiments, the reduction in the azole fungicide concentration is equal or less than 10% after storage for 2 weeks at 54° C.

In some embodiments, the reduction in the azole fungicide concentration is equal or less than 5% after storage for 2 weeks at 54° C.

In some embodiments, the reduction in the amount of the azole fungicide (active content) in presence of copper-based fungicide when the copper-based fungicide and azole fungicide are mixed in the presence of compound (I) is lower than when the copper-based fungicide and azole fungicide are mixed in the absence of compound (I).

In some embodiments, the invention provides a composition comprising any one of the combinations described herein and at least one acceptable additive.

In some embodiments, the agriculturally acceptable additive is an agriculturally acceptable carrier.

In some embodiments, the agriculturally acceptable carrier is water.

In some embodiments, the copper-based fungicide is suspended in the water. In some embodiments, the azole fungicide is suspended in the water.

In some embodiments, the composition comprises at least one water-immiscible carrier.

In some embodiments, the azole fungicide is dissolved in the water-immiscible carrier.

In some embodiments, the composition comprises particles with a particle size distribution (d90) is 10 microns or less. In some embodiments, the composition comprises particles with a particle size distribution (d90) is 7 microns or less. In some embodiments, the composition comprises particles with a particle size distribution (d90) of 4 microns or less.

A composition according to the invention preferably is in the form of a suspension concentrate (SC), suspoemulsion (SE), emulsion (EW), a water dispersible granule (WG), a wettable powder (WP), a dispersion concentrate (DC), a dry powder seed treatment (DS), a water slurriable powder (WS), or a flowable seed treatment (FS). A preferred composition is a suspoemulsion (SE) and suspension concentrate (SC).

In some embodiments, the composition is a suspension concentrate. In some embodiments, the composition is a suspoemulsion.

In some embodiments, the invention provides a composition comprising (1) a copper-based fungicide, (2) an azole fungicide and (3) at least one compatibility agent, for maintaining at least 90% w/w of the amount of the azole fungicide which was used for formulating or preparing the composition, wherein compatibility agent is compound (I) selected from the group consisting of thiourea-based compound, sodium thiosulfate, alkyl amine, thioamide-based compound, and any combination thereof.

In some embodiments, the concentration of the copper-based fungicide is up to 25% by weight based on the total weight of the composition. In some embodiments, the concentration of the copper-based fungicide is about 10% by weight based on the total weight of the composition. In some embodiments, the concentration of the copper-based fungicide in the composition is between about 100 g/L and about 250 g/L, preferably about 110 g/L.

In some embodiments, the concentration of the metallic copper in the formulation comprising the copper-based fungicide is between about 10 g/L to about 250 g/L. In some embodiments, the concentration of the metallic copper in the formulation comprising the copper-based fungicide is between about 50 g/L to about 150 g/L. In some embodiments, the concentration of the metallic copper in the formulation comprising the copper-based fungicide is about 100 g/L.

In some embodiments, the concentration of the metallic copper in the formulation comprising the copper-based fungicide is about 1%-25% by weight based on the total weight of the formulation. In some embodiments, the concentration of the metallic copper in the formulation comprising the copper-based fungicide is about 5%-25% by weight based on the total weight of the formulation. In some embodiments, the concentration of the metallic copper in the formulation comprising the copper-based fungicide is about 5%-15% by weight based on the total weight of the formulation. In some embodiments, the concentration of the metallic copper in the formulation comprising the copper-based fungicide is about 10% by weight based on the total weight of the formulation. In some embodiments, the concentration of the metallic copper in the formulation comprising the copper-based fungicide is 10.1% by weight based on the total weight of the formulation.

In some embodiments, the concentration of the metallic copper in the formulation comprising the copper-based fungicide is up to 25% by weight based on the total weight of the formulation. In some embodiments, the concentration of the metallic copper in the formulation comprising the copper-based fungicide is about 10% by weight based on the total weight of the formulation.

In some embodiments, the concentration of the metallic copper in the formulation comprising the copper-based fungicide is between about 100 g/L and about 250 g/L, preferably about 110 g/L.

In some embodiments, the concentration of the copper-based fungicide in the composition is between about 15% to about 45% by weight based on the total weight of the composition. In some embodiments, the concentration of the copper-based fungicide in the composition is between about 20% to about 35% by weight based on the total weight of the composition. In some embodiments, the concentration of the copper-based fungicide in the composition is between about 25% to about 30% by weight based on the total weight of the composition. In some embodiments, the concentration of the copper-based fungicide in the composition is 28.8% by weight based on the total weight of the composition.

In some embodiments, the concentration of the formulation comprising the copper-based fungicide in the composition is between about 150 g/L and about 500 g/L. In some embodiments, the concentration of the formulation comprising the copper-based fungicide in the composition is between about 300 g/L to about 400 g/L. In some embodiments, the concentration of the formulation comprising the copper-based fungicide in the composition is about 345 g/L.

In some embodiments, the concentration of the metallic copper in the composition is about 0.1% to about 10% by weight based on the total weight of the composition. In some embodiments, the concentration of the metallic copper in the composition is about 0.5% to about 5% by weight based on the total weight of the composition. In some embodiments, the concentration of the metallic copper in the composition is about 2% to about 3% by weight based on the total weight of the composition. In some embodiments, the concentration of the metallic copper in the composition is 2.9% by weight based on the total weight of the composition.

In some embodiments, the copper-based fungicide is copper sulfate. In some embodiments, the copper-based fungicide is copper oxychloride. In some embodiments, the copper-based fungicide is copper hydroxide. In some embodiments, the copper-based fungicide is bordeaux mixture.

In some embodiment, the copper content in the composition is between about 0.5% to 30% by weight based on the total weight of the composition.

In some embodiments, the concentration of the compound (I) in the composition is between about 0.01% to about 10% by weight based on the total weight of the composition. In some embodiments, the concentration of the compound (I) in the composition is between about 0.1% to about 8% by weight based on the total weight of the composition.

In some embodiments, the concentration of the thiourea-based compound in the composition is between about 0.1% to about 5% by weight based on the total weight of the composition.

In some embodiments, the concentration of the thiourea in the composition is between about 0.1% to about 5% by weight based on the total weight of the composition.

In some embodiments, the concentration of the phenylthiourea in the composition is between about 0.1% to about 5% by weight based on the total weight of the composition.

In some embodiments, the concentration of the cyclic thiourea in the composition is between about 0.1% to about 5% by weight based on the total weight of the composition.

In some embodiments, the concentration of the sodium thiosulfate in the composition is between about 1% to about 5% by weight based on the total weight of the composition.

In some embodiments, the concentration of the alkylamine in the composition is between about 0.5% to about 8% by weight based on the total weight of the composition.

In some embodiments, the concentration of the hexamethylene tetra amine in the composition is between about 1% to about 8% by weight based on the total weight of the composition.

In some embodiments, the concentration of the ethylene diamine in the composition is between about 0.5% to about 5% by weight based on the total weight of the composition.

In some embodiments, the concentration of the butylamine in the composition is between about 0.5% to about 5% by weight based on the total weight of the composition.

In some embodiments, the concentration of the diethylamine in the composition is between about 0.5% to about 5% by weight based on the total weight of the composition.

In some embodiments, the concentration of the triethylamine in the composition is between about 0.5% to about 5% by weight based on the total weight of the composition.

In some embodiments, the concentration of the dodecylamine in the composition is between about 0.5% to about 5% by weight based on the total weight of the composition.

In some embodiments, the concentration of the oleylamine in the composition is between about 0.5% to about 5% by weight based on the total weight of the composition.

In some embodiments, the concentration of the thioamide-based compound in the composition is between about 0.1% to about 5% by weight based on the total weight of the composition.

In some embodiments, the concentration of the thioacetamide in the composition is between about 0.1% to about 5% by weight based on the total weight of the composition.

In some embodiments, the concentration of the thiobenzamide in the composition is between about 0.1% to about 5% by weight based on the total weight of the composition.

In some embodiments, the concentration of the azole fungicide in the composition is between about 1% to about 10% by weight based on the total weight of the composition. In some embodiments, the concentration of the azole fungicide in the composition is between about 2% to about 8% by weight based on the total weight of the composition. In some embodiments, the concentration of the azole fungicide in the composition is between about 2.5% to about 6% by weight based on the total weight of the composition. In some embodiments, the concentration of the azole fungicide in the composition is about 3% by weight based on the total weight of the composition.

In some embodiments, the concentration of the prothioconazole in the composition is between about 1% to about 10% by weight based on the total weight of the composition. In some embodiments, the concentration of the prothioconazole in the composition is between about 2% to about 8% by weight based on the total weight of the composition. In some embodiments, the concentration of the prothioconazole in the composition is between about 2.5% to about 6% by weight based on the total weight of the composition. In some embodiments, the concentration of the prothioconazole in the composition is about 3% by weight based on the total weight of the composition.

In some embodiments, the concentration of the additional fungicide in the composition is between about 1% to about 10% by weight based on the total weight of the composition. In some embodiments, the concentration of the additional fungicide in the composition is between about 2% to about 8% by weight based on the total weight of the composition. In some embodiments, the concentration of the additional fungicide in the composition is between about 2.5% to about 6% by weight based on the total weight of the composition. In some embodiments, the concentration of the additional fungicide in the composition is about 3% by weight based on the total weight of the composition.

In some embodiments, the concentration of the copper-based fungicide the composition is between about 0.5% to about 30% by weight based on the total weight of the composition.

In some embodiment, the copper content in the composition is between about 0.5% to 30% by weight based on the total weight of the composition.

In some embodiments, the concentration of the azole fungicide the composition is between about 0.5% to about 20% by weight based on the total weight of the composition.

In some embodiments, the concentration of the strobilurin fungicide the composition is between about 0.5% to about 20% by weight based on the total weight of the composition.

In some embodiments, the concentration of the compound (I) the composition is between about 0.1% to about 20% by weight based on the total weight of the composition. In some embodiments, the concentration of the compound (I) the composition is between about 0.1% to about 5% by weight based on the total weight of the composition

In some embodiments, the weight ratio between the copper based fungicide (metallic copper) to azole fungicide to compound (I) is between about 300:200:1 to about 1:1:40. In some embodiments, the weight ratio between the copper based fungicide (metallic copper) to azole fungicide to compound (I) is between about 50:15:1 to about 1:1:1. In some embodiments, the weight ratio between the copper based fungicide (metallic copper) to azole fungicide to compound (I) is between about 1:1:2 to about 1:1:5. In some embodiments, the weight ratio between the copper based fungicide (metallic copper) to azole fungicide to compound (I) is between about 50:15:1 to about 1:1:5. In some embodiments, the weight ratio between the copper based fungicide (metallic copper) to azole fungicide to compound (I) is 29.3:9.4:1. In some embodiments, the weight ratio between the copper based fungicide (metallic copper) to azole fungicide to compound (I) is 23.5:7.5:1. In some embodiments, the weight ratio between the copper based fungicide (metallic copper) to azole fungicide to compound (I) is 6.3:2:1. In some embodiments, the weight ratio between the copper based fungicide (metallic copper) to azole fungicide to compound (I) is 4.7:1.5:1.

In some embodiments, the weight ratio between the copper based fungicide (metallic copper) to compound (I) is between about 300:1 to about 1:40. In some embodiments, the weight ratio between the copper based fungicide (metallic copper) to compound (I) is about 50:1 to 1:1. In some embodiments, the weight ratio between the copper based fungicide (metallic copper) to compound (I) is about 1:2 to about 1:5. In some embodiments, the weight ratio between the copper based fungicide (metallic copper) to compound (I) is about 50:1 to about 1:5.

In some embodiments, the weight ratio between the copper based fungicide (metallic copper) to compound (I) is 29.3:1, In some embodiments, the weight ratio between the copper based fungicide (metallic copper) to compound (I) is about 23.5:1. In some embodiments, the weight ratio between the copper based fungicide (metallic copper) to compound (I) is about 6.3:1. In some embodiments, the weight ratio between the copper based fungicide (metallic copper) to compound (I) is 4.7:1.

In some embodiments, the weight ratio between the azole fungicide to compound (I) is between about 200:1 to about 1:40. In some embodiments, the weight ratio between the azole fungicide to compound (I) is between about 15:1 to about 1:1. In some embodiments, the weight ratio between the azole fungicide to compound (I) is between about 1:2 to about 1:5. In some embodiments, the weight ratio between the azole fungicide to compound (I) is between about 15:1 to about 1:5. In some embodiments, the weight ratio between the azole fungicide to compound (I) is about 9.4:1. In some embodiments, the weight ratio between the azole fungicide to compound (I) is about 7.5:1. In some embodiments, the weight ratio between the azole fungicide to compound (I) is about 2:1. In some embodiments, the weight ratio between the azole fungicide to compound (I) is about 1.5:1.

In some embodiments, the present invention provides a composition comprising (1) copper-based fungicide in amount of between about 15% to about 45% by weight based on the total weight of the composition, (2) azole fungicide in amount of between about 1% to about 10% by weight based on the total weight of the composition and (3) compound (I) selected from group consisting of thiourea-based compound, sodium thiosulfate, alkyl amine, thioamide-based compound and any combination thereof in amount of between about 0.01% to about 8% by weight based on the total weight of the composition

In some embodiments, the present invention provides a composition comprising (1) copper-based fungicide in amount of between about 20% to about 35% by weight based on the total weight of the composition, (2) azole fungicide in amount of between about 2% to about 8% by weight based on the total weight of the composition and (3) compound (I) selected from group consisting of thiourea-based compound, sodium thiosulfate, alkyl amine, thioamide-based compound and any combination thereof in amount of between about 0.01% to about 8% by weight based on the total weight of the composition

In some embodiments, the present invention provides a composition comprising (1) copper-based fungicide in amount of between about 20% to about 35% by weight based on the total weight of the composition, (2) azole fungicide in amount of between 2% to 8% by weight based on the total weight of the composition and (3) compound (I) selected from group consisting of thiourea-based compound, sodium thiosulfate, alkyl amine, thioamide-based compound and any combination thereof in amount of between 0.1% to 5% compound (I) by weight based on the total weight of the composition.

In some embodiments, the present invention provides a composition comprising (1) copper-based fungicide in amount of between about 20% to about 35% by weight based on the total weight of the composition, (2) azole fungicide in amount of between about 2% to about 8% by weight based on the total weight of the composition and (3) thiourea in amount of between about 0.1% to about 5% by weight based on the total weight of the composition.

In some embodiments, the present invention provides a composition comprising (1) copper-based fungicide in amount of between about 20% to about 45% by weight based on the total weight of the composition, (2) prothioconazole in amount of between about 2% to about 8% by weight based on the total weight of the composition and (3) thiourea in amount of between about 0.1% to about 5% by weight based on the total weight of the composition.

The addition of an additive affects the chemically and physically stability of the compositions. Said additives may, for example, improve the stability of the composition.

In some embodiments, the agriculturally acceptable additive is selected from agriculturally acceptable carriers, buffers, acidifiers, antifoaming agents, anti-freeze agents, solvents, co-solvents, agents, light agents, UV absorbers, radical scavengers and antioxidants, adhesives, neutralizers, thickeners, binders, sequestrates, biocides, drift retardants, surfactants, dispersants, pigments, wetting agents, safeners, and preservatives. Said additives include, but are not limited to, surfactants, pigments, wetting agents, as well as safeners, or such preservatives as bacteriostats or bactericides.

In some embodiments, the agriculturally acceptable additive is an agriculturally acceptable carrier. In some embodiments, the composition comprises at least one agriculturally acceptable carrier.

The addition of small amounts of one or more agriculturally acceptable additives may affect parameters such as stability, efficacy and/or rainfastness of a composition according to the invention. The addition of small amounts of one or more agriculturally acceptable carriers preferably increases stability, efficacy and/or rainfastness of a composition according to the invention.

In some embodiments, the agriculturally acceptable carrier is water.

In some embodiments, the composition comprises about 30% to about 80% by weight of water. In some embodiments, the composition comprises about 40% to about 70% by weight of water. In some embodiments, the composition comprises about 40% to about 80% by weight of water. In some embodiments, the composition comprises about 50% to about 70% by weight of water. In some embodiments, the composition comprises about 50% to about 55% by weight of water. In some embodiments, the composition comprises about 52% by weight of water. In some embodiments, the composition comprises about 53% by weight of water. In some embodiments, the composition comprises about 54% by weight of water. In some embodiments, the composition comprises about 55% by weight of water.

In some embodiments, the composition is an aqueous composition.

In some embodiments, the composition further comprises polyelectrolyte as described in PCT/IB2021/061258.

In some embodiments, the composition is suspension concentrate.

In some embodiments the copper-based fungicide is suspended in the water

In some embodiments, the copper-based fungicide is dissolved in the water

In some embodiments the azole fungicide is suspended in the water

In some embodiments, the composition is suspoemulsion, where the composition comprising at least two carriers (1) water and (2) water-immiscible carrier.

In some embodiments, the composition is suspoemulsion, where the copper-based fungicide is suspended in the water and the azole fungicide and additional fungicide are dissolved in water immiscible carrier.

In some embodiments, both copper-based fungicide and azole fungicide are suspended in the water and the additional fungicide is dissolved in the water immiscible carrier.

In some embodiments, the composition is suspension concentrate, where both copper-based fungicide and azole fungicide are suspended in the water and additional fungicide is dissolved or suspended in the water.

In some embodiments, the composition is suspoemulsion, where both copper-based fungicide and additional fungicide are suspended in the water and additional fungicide is dissolved in the water immiscible carrier.

In some embodiments, the azole fungicide is dissolved in the water-immiscible carrier

In some embodiments, the additional fungicide is selected from the group consisting of strobilurin fungicides, benzamide fungicide, morpholines, QiI fungicide, SDHI and any combination thereof.

In some embodiments, the additional fungicide is suspended in the water and/or dissolved in the water-immiscible carrier.

In another embodiment, the composition comprises: (1) copper-based fungicide, (2) prothioconazole, (3) picoxystrobin and (4) compound (I), wherein (i) the copper-based fungicide and picoxystrobin suspended in water: the prothioconazole dissolved in the water immiscible carrier and (ii) compound (I) is thiourea.

In some embodiments, the copper-based fungicide is bordeaux mixture.

In another embodiment, the composition comprises: (1) copper-based fungicide, (2) prothioconazole, (3) picoxystrobin and (4) compound (I), wherein (i) the copper-based fungicide suspended in water: the prothioconazole and picoxystrobin are dissolved in the water immiscible carrier and (ii) compound (I) is thiourea.

In some embodiments, the copper-based fungicide is copper oxychloride.

In another embodiment, the composition comprises: (1) copper-based fungicide and picoxystrobin suspended in water: (2) prothioconazole dissolved in the water immiscible carrier and (3) compound (I) selected from group consisting of thiourea-based compound, sodium thiosulfate, alkyl amine, thioamide-based compound and any combination thereof.

In another embodiment, the composition comprises: (1) copper-based fungicide suspended in water: (2) prothioconazole and picoxystrobin dissolved in the water immiscible carrier and (3) compound (I) selected from group consisting of thiourea-based compound, sodium thiosulfate, alkyl amine, thioamide-based compound and any combination thereof.

In one embodiment, the composition comprises: (1) copper-based fungicide, prothioconazole and picoxystrobin suspended in the water and (2) compound (I) selected from group consisting of thiourea-based compound, sodium thiosulfate, alkyl amine, thioamide-based compound and any combination thereof.

In another embodiment, the composition comprises: (1) copper-based fungicide and picoxystrobin suspended in water: (2) prothioconazole dissolved in the water immiscible carrier and (3) compound (I) selected from group consisting of thiourea-based compound, hexamethylene tetra amine, sodium thiosulfate, ethylene diamine and any combination thereof.

In another embodiment, the composition comprises: (1) copper-based fungicide suspended in water: (2) prothioconazole and picoxystrobin dissolved in the water immiscible carrier and (3) compound (I) selected from group consisting of thiourea-based compound, hexamethylene tetra amine, sodium thiosulfate, ethylene diamine and any combination thereof.

In one embodiment, the composition comprises: (1) copper-based fungicide, prothioconazole and picoxystrobin suspended in the water and (2) compound (I) selected from group consisting of thiourea-based compound, hexamethylene tetra amine, sodium thiosulfate, ethylene diamine and any combination thereof.

In some embodiments, the composition comprises (1) a copper-based fungicide, (2) picoxystrobin, (3) water, (4) prothioconazole, (5) a water-immiscible carrier, and (6) compound (I) selected from the group consisting of thiourea-based compound, hexamethylene tetra amine, sodium thiosulfate, ethylene diamine and any combinations thereof, wherein the picoxystrobin is suspended in the water and the prothioconazole is dissolved in the water-immiscible carrier.

In some embodiments, the composition comprises (1) copper-based fungicide, (2) prothioconazole, (3) picoxystrobin, (4) water, and (5) compound (I) selected from the group consisting of thiourea-based compound, hexamethylene tetra amine, sodium thiosulfate, ethylene diamine and any combinations thereof, wherein the prothioconazole and the picoxystrobin are suspended in the water.

In some embodiments, water immiscible carrier may include but is not limited to aromatic hydrocarbons (e.g. toluene, o-, m-, p-xylene, ethylbenzene, isopropylbenzene, tert-butylbenzene, naphthalenes, mono- or polyalkyl-substituted naphthalenes), paraffins (e.g. octane, nonane, decane, undecane, dodecane, tridecane, tetradecane, pentadecane, hexadecane, hepta-decane, octa-decane, nona-decane, eicosane, heneicosane, docosane, tricosane, tetracosane, pentacosane, and branched chain isomers thereof), petroleum, ketones (e.g. acetophenone, cyclohexanone), vegetable oil (e.g. olive oil, kapok oil, castor oil, papaya oil, camellia oil, palm oil, sesame oil, corn oil, rice bran oil, peanut oil, cotton seed oil, soy bean oil, rapeseed oil, linseed oil, tung oil, sunflower oil, safflower oil, tall oil), alkyl ester of vegetable oils, (e.g. rapeseed oil methyl ester or rapeseed oil ethyl ester, rapeseed oil propyl esters, rapeseed oil butyl esters, tall oil fatty acids esters etc . . . ), diesel, mineral oil, fatty acid amides (e.g. C₁-C₃ amines, alkylamines or alkanolamines with C₆-C₁₈ carboxylic acids), Dimethylamide of fatty acid, N,N-dimethyl alkylamide (N.N-dimethyl decanamide, N,N-dimethyl octanamide, N, N-dimethyl dodecanamide, N,N-dialkyl alkanamide), N-alkyl alkanamide, fatty acids, tall oil fatty acids, alkyl esters of fatty acids (e.g. C₁-C₄ monohydric alcohol esters of C₈ to C₂₂ fatty acids such as methyl oleate, ethyl oleate), modified vegetable oils and combinations thereof.

In a preferred embodiment, the water immiscible carrier may include but is not limited to aromatic hydrocarbons, fatty acid amides, alkyl ester of vegetable oils and vegetable oils.

In some embodiments, the water immiscible carrier is acetophenone.

In some embodiments, the water immiscible carrier is fatty acid amides.

In some embodiments, the water immiscible carrier is N,N-Dimethyldecanamide.

In an embodiment, the amount of the water immiscible carrier may be about 0.1-20 wt. %, about 1-15 wt. %, or about 0.1-10 wt. %, or about 1-5% based on the total weight of the composition. In a specific embodiment, the non-aqueous liquid carrier may be present in a concentration of about 3% by weight based upon the total weight of the composition.

In some embodiments, the composition further comprises adjuvant.

In some embodiments, the adjuvant in the liquid carrier may include but is not limited to vegetable oils, alkyl esters of vegetable oils such as for example, soy methyl ester, soy ethyl ester, rapeseed oil methyl ester or rapeseed oil ethyl ester, alkoxylated sorbitan esters such as for example sorbitan monolaurate alkoxylates such as for example polyoxyethylene (16) sorbitan monolaurate (Tween™ 24), polyoxyethylene (20) sorbitan monolaurate (Tween™ 20; Alkamuls® PSML-20), polyoxyethylene (4) sorbitan monolaurate (Tween™ 21), polyoxyethylene (8) sorbitan monolaurate (Tween™ 22), polyoxyethylene (12) sorbitan monolaurate (Tween™ 23), sorbitan monolaurate (Alkamuls® S/20, Glycomul® LK, Glycomul® LC, Span® 20), polyoxyethylene (20) sorbitan monostearate alkoxylates such as for example polyoxyethylene (20) sorbitan monostearate (Tween™ 60), polyoxyethylene (4) sorbitan monostearate (Tween™ 61), sorbitan monostearate (Alkamuls® S/90, Glycomul® S, Span® 60), sorbitan monooleate alkoxylates such as for example polyoxyethylene (20) sorbitan monooleate (Tween™ 80, Emulgin® SMO 20, T-Maz® 80, Agnique® SMO 20U), polyoxyethylene (5) sorbitan monooleate (Tween™ 81), sorbitan monooleate (Alkamuls® S/80, Span® 80), and combinations thereof.

In some embodiments, the adjuvant is Synergen SOC.

In some embodiments, the agriculturally acceptable additive refers to surfactant.

In some embodiments, the surfactant is a wetting agent, dispersant, or a combination thereof.

In some embodiments, the composition comprises at least two surfactants.

In some embodiments, the dispersant is polyelectrolyte block copolymer (as described in WO2017/098325).

In some embodiments, the dispersing agent is a block polymer comprises 77% of sodium 2-acryloylamino-2-methylpropane-1-sulfonate (AMPS) monomers and 23% of the ethyl acrylate (EA) monomers.

In some embodiments, the dispersing agent is a water solution of 30% by weight solution of a block polymer comprising 77% of sodium 2-acryloylamino-2-methylpropane-1-sulfonate (AMPS) monomers and 23% of ethyl acrylate (EA) monomers, which may be prepared as described in Example 1 of WO2017/098325.

In some embodiments, wetting agent is alkoxylated alcohol and a di-block EO/PO block copolymer

In some embodiments, wetting agent is atlox 4894.

In some embodiments, the dispersant is an anionic polymeric surfactant.

In some embodiments, anionic polymeric surfactant is Metasperse 500L.

In some embodiments, the anionic polymeric surfactant is sodium lignosulfonate

In some embodiments, the anionic polymeric surfactant is Borosperse CA

In some embodiments, the dispersant is anionic dispersant.

In some embodiments, the anionic dispersant is sodium methyl oleyl taurate.

In some embodiments, the anionic dispersant is Geropon T-77.

In some embodiments, the agriculturally acceptable additive is a dispersant. In some embodiments, the composition comprises at least one dispersant.

In some embodiments the composition comprising at least one anionic dispersant and at least one non-ionic surfactant.

A composition of the invention may also comprise two or more different dispersants.

A dispersant is preferably present in an amount of between 0 to up to 10% (w/v), more preferred between 0.01 to up to 5% (w/v), more preferred between 0.02 to up to 2% (w/v),

In some embodiments, the dispersant is a modified acrylic polymer, non-modified acrylic acid or any combination thereof.

In some embodiments, the modified acrylic polymer is modified styrene acrylic acid, polymethyl methacrylate-polyethylene glycol graft copolymer or any combination thereof. In some embodiments, modified acrylic polymer is modified styrene acrylic polymer. In some embodiments, the modified styrene acrylic polymer is Atlox Metasperse 500L, Atlox Metsaperse 550S (sold by Croda). In some embodiments, the modified acrylic polymer is polymethyl methacrylate-polyethylene glycol graft copolymer.

In some embodiments, the concentration of the dispersant in the composition is about 0.01-15% by weight based on the total weight of the composition.

In some embodiments, the concentration of the dispersant in the composition is about 0.01-12% by weight based on the total weight of the composition. In some embodiments, the concentration of the dispersant in the composition is about 1-12% by weight based on the total weight of the composition. In some embodiments, the concentration of the dispersant in the composition is about 0.01-10% by weight based on the total weight of the composition. In some embodiments, the concentration of the dispersant in the composition is about 1-5% by weight based on the total weight of the composition. In some embodiments, the concentration of the dispersant in the composition is about 5-10% by weight based on the total weight of the composition. In some embodiments, the concentration of the dispersant is about 2% by weight based on the total weight of the composition. In some embodiments, the concentration of the dispersant is about 5% by weight based on the total weight of the composition. In some embodiments, the concentration of the dispersant is about 6% by weight based on the total weight of the composition. In some embodiments, the concentration of the dispersant is about 7% by weight based on the total weight of the composition. In some embodiments, the concentration of the dispersant is about 8% by weight based on the total weight of the composition. In some embodiments, the concentration of the dispersant is about 9% by weight based on the total weight of the composition. In some embodiments, the concentration of the dispersant is about 10% by weight based on the total weight of the composition.

A composition according to the invention may further comprise at least one pH adjuster or buffering agent such as organic or inorganic bases and/or organic or inorganic acids.

In some embodiments, the composition comprises one or more additives such as biocide (preservative) defoaming agents, thickeners and drift retardants.

Wetting agent can be selected from di-octylsulphosuccinate, polyoxyethylene/polypropylene oxide, ethoxylated tristyrylphenol, ethoxylated tristyrylphenol sulphate, ethoxylated tristyrylphenol phosphate, ethoxylated propoxylated tristyryl phenol, and. A composition of the invention may also comprise two or more different wetting agents. A wetting agent is preferably present in an amount of between 0 to up to 10% (w/v), more preferred between 0.01 to up to 5% (w/v), more preferred between 0.02 to up to 1% (w/v), more preferred about 0.05% (w/v).

In some embodiments, the wetting agent is polyalkylene oxide block copolymer. In some embodiments, the wetting agent is butyl block copolymer. In some embodiments, the butyl block copolymer is Atlas™ G5002L (sold by Croda).

In some embodiments, the concentration of the wetting agent in the composition is about 1-10% by weight based on the total weight of the composition. In some embodiments, the concentration of the wetting agent in the composition is 0-5% by weight based on the total weight of the composition. In some embodiments, the concentration of the wetting agent in the composition is about 1-5% by weight based on the total weight of the composition. In some embodiments, the concentration of the wetting agent in the composition is about 1-3% by weight based on the total weight of the composition. In some embodiments, the concentration of the wetting agent in the composition is about 2% by weight based on the total weight of the composition.

In some embodiments, the composition comprises at least one rheology modifier. In some embodiments, the agriculturally acceptable additive is a rheology modifier.

In some embodiments, the rheology modifier is a thickener. In some embodiments, the composition comprises at least one thickener.

A thickening agent, when present, is preferably selected from agar, alginic acid, alginate, carrageenan, gellan gum, xanthan gum, succinoglycan gum, guar gum, acetylated distarch adipate, acetylated oxidised starch, arabinogalactan, ethyl cellulose, methyl cellulose, locust bean gum, starch sodium octenylsuccinate, and triethyl citrate. A composition of the invention may also comprise two or more different thickening agents. A thickening agent is preferably present in an amount of between 0 to up to 10% (w/v), more preferred between 0.01 to up to 5% (w/v), more preferred between 0.02 to up to 1% (w/v), more preferred about 0.05% (w/v).

In some embodiments, the thickener is xanthan gum.

In some embodiments, the rheology modifier is Agrhopol 23, Rhodopol® 23 (sold by Solvay). In some embodiments, the rheology modifier is xanthan gum.

In some embodiments, the antifoaming agent is SAG 1572.

In some embodiments, the concentration of the rheology modifier in the composition is about 0.01-10% by weight based on the total weight of the composition. In some embodiments, the concentration of the rheology modifier in the composition is about 5-10% by weight based on the total weight of the composition. In some embodiments, the concentration of the rheology modifier in the composition is about 6% by weight based on the total weight of the composition. In some embodiments, the concentration of the rheology modifier in the composition is about 8% by weight based on the total weight of the composition.

In some embodiments, the composition comprises at least one thickener and at least one biocide. In some embodiments, the amount of the thickener and the biocide in the composition is up to 1% by weight based on the total weight of the composition.

In some embodiments, the agriculturally acceptable additive is a preservative. In some embodiments, the composition comprises at least one preservative.

In some embodiments, the preservative is a biocide. In some embodiments, the composition comprises at least one biocide. In some embodiments, the preservative is Acticide® MBS.

In some embodiments, the concentration of the preservative in the composition is about 0.01-5% by weight based on the total weight of the composition. In some embodiments, the concentration of the preservative in the composition is about 0.01-1% by weight based on the total weight of the composition. In some embodiments, the concentration of the preservative in the composition is about 0.1% by weight based on the total weight of the composition. In some embodiments, the concentration of the preservative in the composition is 0.083% by weight based on the total weight of the composition.

A composition according to the invention may comprise an additional bioactive ingredient, also termed additional agrochemical, such as a growth regulator, a bio-stimulant, a fungicide, a herbicide, an insecticide, an acaricide, a molluscicide, a miticide, a rodenticide; and/or an bactericide.

Various agrochemicals may be used as additional bioactive ingredient. Exemplary among such agrochemicals without limitation are crop protection agents, for example pesticides, safeners, plant growth regulators, repellents, bio-stimulants and preservatives such as bacteriostats or bactericides.

In some embodiments, the composition comprises at least one additional bioactive ingredient, preferably an additional insecticide, fungicide and/or herbicide.

Additional agrochemicals that may be used with the combination and composition of the present invention are described below.

A composition of the invention may also comprise two or more additional bioactive ingredients, such as two or more fungicides, two or more herbicides, two or more insecticides, two or more acaricides, two or more bactericides, or combinations thereof, such as at least one antifungal compound and at least one insecticide, at least one antifungal compound and at least one herbicide, at least one antifungal compound and at least one acaricide, at least one antifungal compound and at least one bactericide, at least one herbicide and at least one insecticide, at least one herbicide and at least one acaricide, at least one herbicide and at least one bactericide, at least one insecticide and at least one acaricide, at least one insecticide and at least one bactericide, and at least one acaricide and at least one bactericide. Some bioactive ingredients have a wide range of target organisms, as is known to the skilled person, and are therefore include in more than one subgroup of bioactive ingredients. Said at least one additional bioactive ingredient preferably is present in a concentration of between about 0.1 and 90 w/v %, more preferred between about 1 and 70 w/v %, more preferred between about 10 and 50 w/v %.

Said additional bioactive ingredient preferably is an insecticide, a fungicide and/or an herbicide.

The present invention provides a composition comprising
(1) 22.89% by weight of Copper oxychloride tech,
(2) 3.67% by weight of Picoxystrobin tech,
(3) 4.14% by weight of Prothioconazole,
(4) 0.45% by weight of Acetic Acid,
(5) 13.22% by weight of Acetophenone,
(6) 0.2% by weight of AG-RH 23,
(7) 1% by weight of Agnique BP 420,
(8) 2.64% by weight of Agsolex 8,
(9) 1.87% by weight of Borresperse CA,
(10) 0.2% by weight of Chitosan,
(11) 5% by weight of Poly Agro A (30% in water),
(12) 3% by weight of Propylene glycol,
(13) 0.02% by weight of Proxel GXL,
(14) 0.2% by weight of SAG 1572,
(15) 2.54% by weight of sodium acetate,
(16) 2.02% by weight of Soprophor TS/16,
(17) 0.66% by weight of Synergen SOC,
(18) 0.35% by weight of Thiourea,
(19) 0.3% by weight of Van Gel B, and
(20) 35.63% by weight of water.

The present invention provides a composition comprising
(1) 34.53% by weight of Bordeaux Mixture,
(2) 2.7% by weight of Picoxystrobin,
(3) 5% by weight of Propylene Glycol,
(4) 2% by weight of Geropon T-77,
(5) 1% by weight of Borresperse CA,
(6) 1% by weight of Atlox Metasperse 500L,
(7) 3% by weight of Atlox 4894,
(8) 0.1% by weight of SAG 1572,
(9) 0.2% by weight of Proxel GXL,
(10) 2% by weight of ethylene diamine,
(11) 3% by weight of Prothioconazole,
(12) 3% by weight of Rhodiasolv ADMA 10,
(13) 1.5% by weight of Emulsogen TS 200,
(14) 0.2% by weight of Agrhopol 23, and
(15) 39.77% by weight of water.

The present invention provides a composition comprising
(1) 34.53% by weight of Bordeaux Mixture,
(2) 2.7% by weight of Picoxystrobin,
(3) 5% by weight of Propylene Glycol,
(4) 2% by weight of Geropon T-77,
(5) 1% by weight of Borresperse CA,
(6) 1% by weight of Atlox Metasperse 500L,
(7) 3% by weight of Atlox 4894,
(8) 0.1% by weight of SAG 1572,
(9) 0.2% by weight of Proxel GXL,
(10) 1% by weight of sodium thiosulphate,
(11) 0.5% by weight of thiourea,
(12) 3% by weight of Prothioconazole,
(13) 3% by weight of Rhodiasolv ADMA 10,
(14) 1.5% by weight of Emulsogen TS 200,
(15) 0.2% by weight of Agrhopol 23, and
(16) 41.27% by weight of water.

The present invention provides a composition comprising
(1) 34.53% by weight of Bordeaux Mixture,
(2) 2.7% by weight of Picoxystrobin,
(3) 5% by weight of Propylene Glycol,
(4) 2% by weight of Geropon T-77,
(5) 1% by weight of Borresperse CA,
(6) 1% by weight of Atlox Metasperse 500L,
(7) 3% by weight of Atlox 4894,
(8) 0.1% by weight of SAG 1572,
(9) 0.2% by weight of Proxel GXL,
(10) 0.32% by weight of thiourea,
(11) 3% by weight of Prothioconazole,
(12) 3% by weight of Rhodiasolv ADMA 10,
(13) 1.5% by weight of Emulsogen TS 200,
(14) 0.2% by weight of Agrhopol 23, and
(15) 42.45% by weight of Water.

### Method and Uses

The present invention provides a method for preventing and/or reducing the reduction of the azole fungicide amount in composition comprises copper-based fungicide and azole fungicide, the method comprises adding a compound (I) selected from group consisting of thiourea-based compound, sodium thiosulfate, alkyl amine, thioamide-based compound and any combination thereof to the composition.

In some embodiments, the present invention provides a method for preventing and/or reducing the reduction of the azole fungicide amount in composition comprises copper-based fungicide and azole fungicide, the method comprises adding a compound (I) selected from the group consisting of thiourea-based compound, hexamethylene tetra amine, sodium thiosulfate, ethylene diamine and any combination thereof to the composition.

In some embodiments, adding refer to adding the compound (I) before adding the azole fungicide to the composition.

The present invention provides a method for preventing and/or reducing the reduction of the azole fungicide concentration in presence of copper-based fungicide, method comprises interacting the copper-based fungicide with a compound (I) selected from group consisting of thiourea-based compound, sodium thiosulfate, alkyl amine, thioamide-based compound and any combination thereof.

In some embodiments, the invention provides a method for preventing and/or reducing the rate and/or extent of reduction of the amount of azole fungicide in a composition which comprises copper-based fungicide and the azole fungicide, the method comprising including a compound (I) selected from the group consisting of thiourea-based compound, hexamethylene tetra amine, sodium thiosulfate, ethylene diamine and any combinations thereof in the composition.

In some embodiments, the compound (I) is added before adding the azole fungicide when formulating or preparing the composition.

In some embodiments, compound (I) is added no later than 30 minutes after the addition of the last of the azole fungicide and the copper-based fungicide. In some embodiments, compound (I) is added no later than 15 minutes after the addition of the last of the azole fungicide and the copper-based fungicide. In some embodiments, compound (I) is added no later than 5 minutes after the addition of the last of the azole fungicide and the copper-based fungicide. In some embodiments, compound (I) is added no later than the addition of the last of the azole fungicide and the copper-based fungicide.

The present invention provides use of compound (I) selected from group consisting of thiourea-based compound, sodium thiosulfate, alkyl amine, thioamide-based compound and any combination thereof for formulating or preparing a composition comprises copper-based fungicide, azole fungicide and water.

The present invention provides use of compound (I) selected from group consisting of thiourea-based compound, sodium thiosulfate, alkyl amine, thioamide-based compound and any combination thereof for formulating or preparing a composition comprises copper-based fungicide, azole fungicide and water, wherein the composition comprises at least 90% of the amount of the azole fungicide which was used for formulating or preparing the composition.

The present invention provides use of compound (I) selected from group consisting of thiourea-based compound, sodium thiosulfate, alkyl amine, thioamide-based compound and any combination thereof for formulating or preparing a composition comprises copper-based fungicide, azole fungicide and water, wherein the composition comprises at least 95% of the amount of the azole fungicide which was used for formulating or preparing the composition

In some embodiments, the concentration of the azole fungicide in presence of copper-based fungicide and in absence of compound (I) selected from group consisting of thiourea-based compound, sodium thiosulfate, alkyl amine, thioamide-based compound and any combination thereof, is lower than when the copper-based fungicide and azole fungicide are mixed in the same amount in the presence of the compound (I).

The present invention provides a method for preventing and/or reducing the reduction of the azole fungicide concentration in presence of copper-based fungicide, method comprises interacting the copper-based fungicide with a compound (I) selected from the group consisting of thiourea-based compound, hexamethylene tetra amine, sodium thiosulfate, ethylene diamine and any combination thereof.

The present invention provides use of compound (I) selected from the group consisting of thiourea-based compound, hexamethylene tetra amine, sodium thiosulfate, ethylene diamine and any combination thereof for formulating or preparing a composition comprises copper-based fungicide, azole fungicide and water.

In some embodiments, the invention provides use of a compound (I) for reducing the rate and/or extent of reduction or for preventing the reduction of the amount of azole fungicide in a composition comprising (1) copper-based fungicide and (2) azole fungicide, so that the rate and/or extent of reduction in the amount of the azole amount is lower than the rate and/or extent of reduction of the amount of the azole fungicide in the same composition without compound (I). The amount of free azole fungicide in the composition may be detected by HPLC at same RT as the azole used to formulate the composition.

In some embodiments, the invention provides compound (I) for reducing the rate and/or extent of reduction or for preventing the reduction of the amount of azole fungicide in a composition comprising (1) copper-based fungicide and (2) azole fungicide, so that the rate and/or extent of reduction in the amount of the azole amount is lower than the rate and/or extent of reduction of the amount of the azole fungicide in the same composition without compound (I). The amount of free azole fungicide in the composition may be detected by HPLC at same RT as the azole used to formulate the composition.

In some embodiments, the concentration of the azole fungicide in presence of copper-based fungicide and in absence of compound (I) selected from the group consisting of thiourea-based compound, hexamethylene tetra amine, sodium thiosulfate, ethylene diamine and any combination thereof, is lower than when the copper-based fungicide and azole fungicide are mixed in the same amount in the presence of the compound (I).

In some embodiments, the reduction in the azole fungicide concentration is equal or less than 10% during storage for 2 weeks at 54° C.

In some embodiments, the reduction in the azole fungicide concentration is equal or less than 5% during storage for 2 weeks at 54° C.

The present invention also provides the use of compound (I) for reducing or eliminate the reduction of the amount of the azole fungicide in composition comprising (1) copper-based fungicide and (2) azole fungicide, wherein the rate and/or extent of reduction in the azole amount is lower than the rate and/or extent of reduction of azole amount in the same composition without adding compound (I).

### Process

The present invention provides a process for formulating or producing a composition comprising a copper-based fungicide and azole fungicide, the process comprising the following steps: (a) preparing an aqueous composition of the copper-based fungicide and compound (I) selected from group consisting of thiourea-based compound, sodium thiosulfate, alkyl amine, thioamide-based compound and any combination thereof, (b) mixing with azole fungicide.

In some embodiments, the present invention provides a process for formulating or producing a composition comprising a copper-based fungicide and azole fungicide, the process comprising the following steps: (a) preparing an aqueous composition of the copper-based fungicide and compound (I) selected from group consisting of thiourea-based compound, hexamethylene tetra amine, sodium thiosulfate, ethylene diamine and any combination thereof, (b) mixing with azole fungicide.

The present invention also provides a process for formulating or preparing a composition comprising a copper-based fungicide, an azole fungicide, and compound (I), wherein the process comprises the following steps: (a) preparing an aqueous composition of the copper-based fungicide and compound (I) selected from group consisting of thiourea-based compound, hexamethylene tetra amine, sodium thiosulfate, ethylene diamine and any combination thereof, (b) mixing the aqueous composition with the azole fungicide.

In some embodiments, the azole fungicide is in form of an emulsifiable concentrate composition.

In some embodiments, the azole fungicide is in form of suspension concentrate

In some embodiments the composition further comprises additional fungicide(s)

In some embodiments, the compound (I) selected from the group consisting of thiourea-based compound, hexamethylene tetra amine, sodium thiosulfate, ethylene diamine and any combination thereof is mixed with the copper-based fungicide prior to adding azole fungicide.

The present invention provides a process for preparation of or formulation of a composition comprising a copper-based fungicide, azole fungicide compound (I), the process comprising preparing a suspension concentrate comprising the copper-based fungicide and compound (I), preparing an emulsifiable concentrate composition comprising the azole fungicide and mixing the two compositions to obtain suspoemulsion composition.

The present invention provides a process for preparation of or formulation of a composition comprising a copper-based fungicides, azole fungicide and compound (I), the process comprising preparing a suspension concentrate comprising the copper-based fungicide and compound (I), preparing a suspension concentrate composition comprising the azole fungicide and mixing the two compositions to obtain suspension concentrate composition.

In some embodiments, the composition further comprises additional fungicide, which can be part of the suspension concentrate comprises the copper-based fungicide and/or part of the suspension concentrate comprises the azole fungicide and/or when the composition SE composition, the additional fungicide can be dissolved in the emulsifiable part.

In some embodiments, the process comprises adding other additives, dispersant, wetter, antifoam, and rheology modifying agent.

In some embodiments, the process further comprises a step of milling or grinding the resultant copper-based fungicide to reduce their particle size to any of the particle sizes described herein.

In some embodiments, the process further comprises milling or grinding the resultant copper-based fungicide to reduce their particle size such that the particles have a d90 of 10 microns or less and a d50 of 5 microns or less.

In some embodiments, the compound (I) is added by prior to addition of the azole fungicide.

The present invention provides a process for preparation of or formulation of a composition comprising a copper-based fungicide, azole fungicide and compound (I), the process comprising preparing a suspension concentrate comprising the copper-based fungicide, preparing an emulsifiable concentrate composition comprising the azole fungicide and mixing the two compositions to obtain suspoemulsion composition.

The present invention provides a process for preparation of or formulation of a composition comprising a copper-based fungicide, azole fungicide and compound (I), the process comprising preparing a suspension concentrate comprising the copper-based fungicide, preparing a suspension concentrate composition comprising the azole fungicide and mixing the two compositions to obtain suspension concentrate composition.

In some embodiments, the azole fungicide is added to the copper-based fungicide any time after the mixing of the compound (I) and copper-based fungicide.

In some embodiments, the composition further comprises additional fungicide, which can be part of the suspension concentrate comprises the copper-based fungicide and/or part of the suspension concentrate comprises the azole fungicide and/or when the composition SE composition, the additional fungicide can be dissolved in the emulsifiable part.

The present invention provides a process for preparation of or formulation of a composition comprising a copper-based fungicide, azole fungicide and agent, the process comprising preparing a suspension concentrate comprising the copper-based fungicide and compound (I), preparing an emulsifiable concentrate composition comprising the azole fungicide and mixing the two compositions to obtain suspoemulsion composition.

The present invention provides a process for preparation of or formulation of a composition comprising a copper-based fungicide, azole fungicide and compound (I), the process comprising preparing a suspension concentrate comprising the copper-based fungicide and compound (I), preparing a suspension concentrate composition comprising the azole fungicide and mixing the two compositions to obtain suspension concentrate composition.

In some embodiments, the composition further comprises additional fungicide, which can be part of the suspension concentrate comprises the copper-based fungicide and/or part of the suspension concentrate comprises the azole fungicide and/or when the composition SE composition, the additional fungicide can be dissolved in the emulsifiable part.

In some embodiments, when the composition further comprises a water immiscible carrier (SE), the process further comprises mixing with an emulsifiable concentrate (EC) comprising the additional fungicide.

In some embodiments, the emulsifiable concentrate (EC) comprises a solution of azole and strobilurin and/or any other fungicide different from copper-based fungicide in a water immiscible carrier.

In some embodiments, the organic phase includes at least one water immiscible carrier.

In some embodiments, the water immiscible carrier is fatty acid amide.

In some embodiments, the organic phase includes at least one water immiscible carrier such as N,N-Dimethyldecanamide.

### Azole Fungicide

In some embodiments, azole fungicide may include but is not limited to azaconazole, bitertanol, bromuconazole, cyproconazole, difenoconazole, diniconazole, epoxiconazole, etaconazole, fenbuconazole, fluquinconazole, flusilazole, flutriafol, hexaconazole, imibenconazole, ipconazole, metconazole, myclobutanil, penconazole, propiconazole, simeconazole, tebuconazole, tetraconazole, triadimefon, triadimenol, triticonazole, prothioconazole and mefentrifluconazole.

In some embodiments, the azole fungicide is selected from the group consisting of azaconazole, bitertanol, bromuconazole, cyproconazole, difenoconazole, diniconazole, epoxiconazole, etaconazole, fenbuconazole, fluquinconazole, flusilazole, flutriafol, hexaconazole, imibenconazole, ipconazole, metconazole, myclobutanil, penconazole, propiconazole, simeconazole, tebuconazole, tetraconazole, triadimefon, triadimenol, triticonazole, prothioconazole, mefentrifluconazole, and any combination thereof.

In some embodiments, the azole fungicide is tebuconazole

In some embodiments, the azole fungicide is prothioconazole

In some embodiments, the azole fungicide is cyproconazole

In some embodiments, the azole fungicide is difenoconazole

### Additional Fungicide

In some embodiments, the additional fungicide is selected from the group consisting of strobilurin fungicides, benzamide fungicide, morpholines, QiI fungicide, SDHI and any combination thereof.

In some embodiments, the additional fungicide is at least partially suspended in the water and/or at least partially dissolved in the water-immiscible carrier.

In some embodiments, the additional fungicide is a strobilurin fungicide. In some embodiments, the additional fungicide is a benzamide fungicide. In some embodiments, the additional fungicide is a morpholine. In some embodiments, the additional fungicide is a QiI fungicide. In some embodiments, the additional fungicide is a SDHI.

In some embodiments, the additional fungicide comprises picoxystrobin and/or azoxystrobin and/or fluxapyroxad.

In some embodiments, strobilurin fungicide may include but is not limited to azoxystrobin, coumoxystrobin, enoxastrobin, flufenoxystrobin, picoxystrobin, pyraoxystrobin, mandestrobin, pyraclostrobin, pyrametostrobin, triclopyricarb, kresoxim-methyl, trifloxystrobin, dimoxystrobin, fenaminstrobin, metominostrobin, orysastrobin, metyltetraprole and fluoxastrobin.

In some embodiments, the strobilurin fungicide is selected from group consisting of picoxystrobin, trifloxystrobin, azoxystrobin, pyraclostrobin, metominostrobin, metyltetraprole, mandestrobin and a combination thereof.

In some embodiments, the strobilurin fungicide is picoxystrobin.

In some embodiments, the strobilurin fungicide is azoxystrobin.

In some embodiments, the SDHI may include but is not limited to penthiopyrad, boscalid, flutolanil, fluxapyroxad, inpyrfluxam, fluopyram, fluindapyr, benzodiflupyr, bixafen and pydiflumetofen

In some embodiments, the SDHI fungicide is selected from group consisting of bixafen; fluxapyroxad, fluindapyr: inpyrfluxam, benzodiflupyr and pydiflumetofen.

In some embodiments, the SDHI fungicide is fluxapyroxad.

In some embodiments, QiI fungicide may include but is not limited to cyazofamid, amisulbrom and fenpicoxamid.

In some embodiments, QiI is fenpicoxamide.

In some embodiments, morpholines may include but is not limited to aldimorph, fenpropimorph, ridemorph, dodemorph, spiroxamine, piperalin, fenpropidin.

In some embodiments, the additional fungicide is flumetylsulforim. (5-fluoro-4-imino-3-methyl-1-tosyl-3,4-dihydropyrimidin-2 (1H)-one).

### Copper-Based Fungicide

In some embodiments, the copper-based fungicide is soluble in water

In some embodiments, the copper-based fungicide is not soluble in water

In some embodiments, the copper-based fungicide is selected from group consisting of cupric acetate, cupric chloride, cupric chlorate, cupric formate, cupric hexafluorosilicate, cupric nitrate, cupric chromate, copper sulfate pentahydrate, bordeaux mixture, copper hydroxide, cuprous oxide, copper oxychloride, copper oxychloride sulfate (COCS), tribasic copper sulfate such as cupric sulfate, tricupric hydroxide, hemihydrate, and any combination thereof.

In some embodiments, the copper-based fungicide may be but not limited to cupric acetate, cupric chloride, cupric chlorate, cupric formate, cupric hexafluorosilicate, cupric nitrate, cupric chromate, copper sulfate pentahydrate, bordeaux mixture, copper hydroxide, cuprous oxide, copper oxychloride, copper oxychloride sulfate (COCS), tribasic copper sulfate such as cupric sulfate, tricupric hydroxide, hemihydrate, or any combination thereof.

In some embodiments, the copper-based fungicide is selected from the group consisting of cupric acetate, cupric chloride, cupric chlorate, cupric formate, cupric hexafluorosilicate, cupric nitrate, cupric chromate, copper sulfate pentahydrate, Bordeaux mixture, cuprous oxide, copper oxychloride, and any combination thereof.

In some embodiments, the copper-based fungicide is bordeaux mixture.

In some embodiments, the copper-based fungicide is copper hydroxide.

In some embodiments, the copper-based fungicide is copper oxychloride.

In some embodiments, the copper-based fungicide is selected from the group consisting of copper sulfate pentahydrate, Bordeaux mixture and any combination thereof.

As used herein, the term “copper-based fungicide” refers to copper salt (such as copper sulfate, copper hydroxychloride, and copper oxide) and/or metallic copper.

As used herein, the term “metallic copper” refers to Cu²⁺ cation.

### Compound (I)

The compound (I) is selected from group consisting of thiourea-based compound, sodium thiosulfate, alkyl amine, thioamide-based compound and any combination thereof.

In some embodiments, the compound (I) is selected from group consisting of thiourea-based compound, hexamethylene tetra amine, sodium thiosulfate, ethylene diamine and any combination thereof.

In some embodiments, the compound (I) is a mixture of two compounds selected from the group consisting of thiourea-based compound, sodium thiosulfate, alkyl amine and thioamide-based compound.

In some embodiments, the compound (I) is a mixture of two compounds selected from the group consisting of thiourea-based compound, hexamethylene tetra amine, sodium thiosulfate and ethylene diamine.

In some embodiments, the compound (I) is thiourea-based compound.

In some embodiments, the thiourea-based compound is thiourea.

In some embodiments, thiourea refers to the compound with the formula SC(NH₂)₂ and the structure H₂N—C(═S)—NH₂ (a.k.a. thiourea material, CAS number: 62-56-6).

Thiourea-based compound refers to a compound having the structure represented by the formula:

R¹NH—C(═S)—NHR²
wherein,
   (i) R¹, R², are both H;
   (ii) R¹ is H and R² is alkyl or alkenyl or alkynyl or aryl or heterocyclic;
   (iii) R¹, R² are each, independently, alkyl, alkenyl or alkynyl;
   (iv) R¹, R² are each, independently, aryl, or heterocyclic;
   (v) R¹ is alkyl or alkenyl or alkynyl and R² is aryl or heterocyclic, or
   (vi) R¹ and R² can be taken together with the nitrogens to which they are attached to form a ring containing 2 to 4 atoms of carbon and optionally one additional atom of nitrogen, sulfur or oxygen, said ring may be saturated or unsaturated and optionally substituted with 1 to 4 substituents selected from the group consisting of C₁-C₂ alkyl, halogen, CN, NO₂ and C₁-C₂ alkoxy.

In some embodiments, alkyl, which may be optionally substituted, denotes a linear or branched or cyclic hydrocarbon group comprising n carbon atoms.

In some embodiments, alkenyl, which may be optionally substituted, denotes a linear or branched or cyclic hydrocarbon group comprising n carbon atoms and at least one double bond.

In some embodiments, alkynyl which may be optionally substituted, denotes a linear or branched hydrocarbon group comprising n carbon atoms and at least one triple bond.

In some embodiments, aryl, which may be optionally substituted, denotes to carbocyclic aromatic radicals having from 6 to 14 carbon atoms.

In some embodiments, heterocyclic, which may be optionally substituted, denotes saturated, partially saturated or fully unsaturated cyclic radical, which contains 3 to 6 ring atoms, of which 1 to 4 are from the group consisting of oxygen, nitrogen and sulfur.

In some embodiments, the thiourea-based compound is butyl thiourea, methyl propyl thiourea, phenylthiourea, ethylphenylthiourea, or diphenylthiourea.

In some embodiments, the thiourea-based compound is cyclic thiourea.

In some embodiments, Compound (I) is not a fungicidally active ingredient.

In some embodiments, Compound (I) is selected from thiourea-based compound which are not pesticidally active.

In some embodiments, the selected compound (I) is a thioamide-based compound.

In some embodiments, the thioamide-based compound may include but is not limited to thioacetamide, thiobenzamide, furan thioamide, pyridine thioamide and polythioamide.

In some embodiments, the thioamide-based compound is selected from the group consisting of thioacetamide, thiobenzamide, furan thioamide, pyridine thioamide and polythioamide.

In some embodiments, the compound (I) is sodium thiosulfate.

In some embodiments, the compound (I) is alkylamine. In some embodiments, the compound (I) comprises one or more alkylamines.

In some embodiments, the alkylamine comprises one or more mono amines.

In some embodiments, the alkylamine is mono amine.

In some embodiments, the alkylamine is a diamine.

In some embodiments, the alkylamine is a polyamine.

In some embodiments, the polyamine is hexamethylene tetra amine.

In some embodiments, the diamine is ethylene diamine.

In some embodiments, the alkylamine is represented by the structure A;

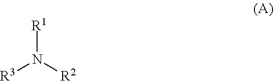

wherein:
   (i) R¹ is hydrogen, alkyl, aryl, alkenyl, alkynyl or heterocyclic; R² is hydrogen, alkyl, aryl, alkenyl, alkynyl or heterocyclic; and R³ is hydrogen, alkyl, aryl, alkenyl, alkynyl or heterocyclic; and
   (ii) at least one of R¹, R², and R³ is alkyl, aryl, alkenyl, alkynyl or heterocyclic.

In some embodiments, alkyl, which may be optionally substituted, denotes a linear or branched or cyclic hydrocarbon group comprising n carbon atoms.

In some embodiments, alkenyl, which may be optionally substituted, denotes a linear or branched or cyclic hydrocarbon group comprising n carbon atoms and at least one double bond.

In some embodiments, alkynyl which may be optionally substituted, denotes a linear or branched, hydrocarbon group comprising n carbon atoms and at least one triple bond.

In some embodiments, aryl, which may be optionally substituted, denotes to carbocyclic aromatic radicals having from 6 to 14 carbon atoms.

In some embodiments, heterocyclic, which may be optionally substituted, denotes saturated, partially saturated or fully unsaturated cyclic radical, which contains 3 to 6 ring atoms, of which 1 to 4 are from the group consisting of oxygen, nitrogen and sulfur.

In some embodiments, substituted means that the group (R¹, R² and/or R³) may or may not be further substituted by one or more groups such as Cₙ alkyl, aryl, halogen, hydroxyl, thio, amino, cyano, oxo, nitro, acyl, amido, C₁₋₆ alkoxy, C₁₋₆ alkenyloxy, aryloxy, acyloxy, C₁₋₆ alkylamino, arylamino, C₁₋₆ alkylthio, arylthio, alkylsulfonyl, arylsulfonyl, alkylsulfinyl, arylsulfinyl, C₁₋₈ alkylamido, and carboxyl.

In some embodiments, two or more of, R¹, R², R³ are the same.

In some embodiments, each of R¹, R², R³ are different.

In some embodiments where one or more of R¹, R², R³ is alkyl, one or more alkyl is linear.

In some embodiments, an alkyl is cyclic.

In some embodiments, an alkyl is an alkyl fatty chain.

In some embodiments, R¹, R² and R³ are methyl.

In some embodiments, R¹, R² and R³ are ethyl.

In some embodiments, the R¹ and R² are H and R³ is C₁₂ alkyl.

In some embodiments, the R¹ and R² are H and R³ is C₁₈ alkenyl.

In some embodiments, the selected compound (I) is an alkyl amine which is oleyl amine.

In some embodiments, the alkylamine is dodecyl amine.

In some embodiments, the alkylamine is benzyl amine.

In some embodiments, compound (I) is hexamethylene tetra amine.

In some embodiments, compound (I) is sodium thiosulfate.

In some embodiments, compound (I) is ethylene diamine.

In some embodiments, alkylamine is Butylamine.

In some embodiments, alkylamine is Diethyl amine.

In some embodiments, alkylamine is Triethylamine.

In some embodiments, compound (I) comprises thiourea.

In some embodiments, compound (I) comprises thioamide-based compound.

In some embodiments, compound (I) comprises sodium thiosulfate.

In some embodiments, compound (I) comprises alkylamine

In some embodiments, compound (I) comprises ethylene diamine.

In some embodiments, alkylamine comprises Butylamine.

In some embodiments, alkylamine comprises Diethyl amine.

In some embodiments, alkylamine comprises Triethylamine

In some embodiments, compound (I) is mixture of two compounds (I) and the weight ratio between them is from 10:1 to 1:10.

In some embodiments, compound (I) is a mixture of thiourea and sodium thiosulfate.

In some embodiments, the weight ratio between the thiourea and sodium thiosulfate is from 10:1 to 1:10.

In some embodiments, the weight ratio between the thiourea and sodium thiosulfate is from 10:1 to 1:10.

In some embodiments, compound (I) is a mixture of hexamethylene tetra amine and thiourea.

In some embodiments, the weight ratio between the thiourea and hexamethylene tetra amine is from 10:1 to 1:10.

In some embodiments, compound (I) is a mixture of hexamethylene tetra amine and sodium thiosulfate.

In some embodiments, the weight ratio between the hexamethylene tetra amine and sodium thiosulfate is from 10:1 to 1:10

In some embodiments, compound (I) is a mixture of sodium thiosulfate and ethylene diamine.

In some embodiments the weight ratio between the sodium thiosulfate and ethylene diamine is from 10:1 to 1:10.

In some embodiments, compound (I) is a mixture of thiourea and ethylene diamine.

In some embodiments, the weight ratio between the thiourea and ethylene diamine is from 10:1 to 1:10.

### Diluted Composition.

In some embodiments, when the combination of the present invention, which comprises copper-based fungicide, azole fungicide and compound (I) is mixed with water, the copper-based fungicide is dispersed as solid particles in the water and the azole fungicide is dispersed as oil drop to form diluted suspoemulsion.

In some embodiments, when the combination of the present invention, which comprises copper-based fungicide, azole fungicide and compound (I) is mixed with water, the copper-based fungicide and the azole fungicide are dispersed as solid particles in the water to form diluted suspension.

In some embodiments, the combination is tank mix.

The present invention provides a diluted suspoemulsion prepared from the combination and/or composition described herein.

The present invention provides a diluted suspension prepared from the combination and/or composition described herein.

### Methods of Use

The present invention also provides a method for controlling fungicidal disease comprising applying an effective amount of any one of the herein described combination and/or composition and/or diluted composition to a plant, a locus thereof, propagation material thereof, or an area infested with the unwanted insects so as to thereby control the pathogen disease.

Controlling refer to preventing curative and persistence.

The present invention also provides a method for controlling plant disease caused by pathogen comprising applying an effective amount of any one of the herein described combination and/or composition and/or diluted composition to a plant, a locus thereof, propagation material thereof, or an area infested with the unwanted insect so as to thereby control the plant disease caused by pathogen.

In some embodiments, the locus of the plant is the vicinity of the plant.

In some embodiments, the area infested with the pathogen.

The present invention provides a method for controlling pathogen infection comprising applying a composition comprising (1) an amount of copper-based fungicide, (2) an amount of azole fungicide and (3) at least one agriculturally acceptable additive, wherein the composition is formulated with compound (I) selected from group consisting of thiourea-based compound, sodium thiosulfate, alkyl amine, thioamide-based compound and any combination thereof.

The present invention provides a method for controlling pathogen infection comprising applying a composition comprising (1) an amount of copper-based fungicide, (2) an amount of azole fungicide and (3) at least one agriculturally acceptable additive, wherein the composition is formulated with compound (I) selected from group consisting of thiourea-based compound, hexamethylene tetra amine, sodium thiosulfate, ethylene diamine and any combination thereof.

In some embodiments, the amount of the azole fungicide in the composition which comprises of copper-based fungicide and in absence of compound (I) selected from group consisting of thiourea-based compound, sodium thiosulfate, alkyl amine, thioamide-based compound and any combination thereof is lower than when the copper-based fungicide and azole fungicide are mixed in the presence of the compound (I).

In some embodiments, the amount of the azole fungicide in the composition which comprises of copper-based fungicide and in absence of compound (I) selected from the group consisting of thiourea-based compound, hexamethylene tetra amine, sodium thiosulfate, ethylene diamine and any combination thereof, is lower than when the copper-based fungicide and azole fungicide are mixed in the presence of the compound (I).

In some embodiments, the amount of the azole fungicide in the composition which comprises of copper-based fungicide and in absence of compound (I) selected from group consisting of thiourea-based compound, sodium thiosulfate, alkyl amine, thioamide-based compound and any combination thereof is lower than when the copper-based fungicide and azole fungicide are mixed in the presence of the compound (I), wherein the same amount of the same azole fungicide and same copper-based fungicide is used for formulating or preparing the composition.

The present invention also provides use of the combination and/or composition, described herein for treating a plant, or a part of a plant, against a pathogen.

The present invention also provides use of the combination, and/or composition described herein for reducing the rate of application required for treating a plant, or a part of a plant, against a pathogen.

The present invention provides a method of treating a plant, or a part of a plant, against a pathogen, comprising contacting the plant, or part of the plant, with any one or any combination and/or composition described herein.

In some embodiments, treating comprises preventing, reducing and/or eliminating the presence of the pathogen on the plant, or part of the plant. In some embodiments, treating comprises controlling diseases caused by the pathogen.

In some embodiments, the method of treating the plant, or the part of a plant against a pathogen comprises protecting the plant, or a part of a plant, against the pathogen, comprising contacting the plant, or part of the plant, with any one of any combination, and/or composition, described herein.

In some embodiments, the method of treating the plant, or the part of a plant against a pathogen comprises preventing, reducing and/or eliminating the presence of the pathogen on the plant, or part of the plant, comprising contacting the plant, or part of the plant, with any one of any combination and/or composition described herein.

In some embodiment, the method of treating the plant, or the part of a plant against a pathogen comprises controlling diseases caused by phytopathogenic fungi in plants or on propagation material thereof, which method comprises contacting the plants, or propagation material thereof, with any one of any combination and/or composition described herein.

In some embodiments, the method of treating the plant, or the part of a plant against a pathogen comprises improving pest control comprising applying any one of any combination and/or composition described herein to a plant/or soil.

In some embodiments, the pathogen is phytopathogenic fungi and the method comprises controlling diseases caused by phytopathogenic fungi in the plant or on propagation material thereof comprising contacting the plant, or propagation material thereof, with any one of any combination and/or composition described herein.

The invention further provides a method of protecting a plant or plant part against a pathogen, comprising contacting said plant or said plant part with a diluted aqueous composition according to this invention.

The invention further provides a method of preventing, reducing and/or eliminating the presence of a pathogen on a plant, or a part of a plant, comprising contacting said plant, or part of said plant, with an aqueous composition according to this invention.

In some embodiments, the method of treating the plant, or the part of a plant against a pathogen comprises preventing, reducing and/or eliminating the presence of the pathogen on the plant, or part of the plant, comprising contacting the plant, or part of the plant, with any one of any combination and/or composition, described herein

The invention further provides a method of controlling diseases caused by phytopathogenic fungi in plants or on propagation material thereof, which method comprises contacting the plants, or propagation material thereof, with a composition according to the invention, including an aqueous diluted composition.

Rate of application may refer to an application rate of 22 g a.i./ha additional fungicide (a.i.)/ha to 2.2 g a.i./ha, 0.22 g a.i./ha, 0.022 g a.i./ha, 0.0022 g a.i./ha, 750 g a.i./ha, 450 g a.i./ha, 375, 150 g a.i./ha, 15 g a.i./ha, 2.9 gr a.i./lit, 11.6 gr a.i./lit, preferably 0.0022 g a.i./ha to 0.75 kg a.i./ha. Rate of application may refer to an application rate of 22 g a.i./ha to 2.2 g a.i./ha of additional fungicide. In some embodiments, the copper-based fungicide is applied at a rate of 750 g a.i./ha, 605 mg a.i./ha, or 500 mg a.i./ha.

In some embodiments, the combination and/or composition is applied at an amount of 0.01-5 g/ha of the copper-based fungicide. In some embodiments, the combination and/or composition, is applied at an amount of 0.01-3 g/ha of the copper-based fungicide. In some embodiments, the combination and/or composition, is applied at an amount of 0.01-2 g/ha of the copper-based fungicide. In some embodiments, the combination and/or composition, is applied at an amount of 0.01-1 g/ha of the copper-based fungicide.

In some embodiments, the combination and/or composition, is applied at an amount of 0.018 g/ha of copper-based fungicide. In some embodiments, the combination and/or composition, is applied at an amount of 0.97 g/ha of copper-based fungicide. In some embodiments, the combination and/or composition, is applied at an amount of 0.39 g/ha of copper-based fungicide. In some embodiments, the combination and/or composition, is applied at an amount of 1.56 g/ha of copper-based fungicide.

In some embodiments, the combination and/or composition, is applied at an amount between 0.001 g/ha to 1000 g/ha of copper metal. In some embodiments, the combination and/or composition, is applied at an amount between 100 g/ha to 1000 g/ha of copper metal. In some embodiments, the combination and/or composition, is applied at an amount between 100 g/ha to 500 g/ha of copper metal. In some embodiments, the combination and/or composition, is applied at an amount between 500 g/ha to 1000 g/ha of copper metal. In some embodiments, the combination and/or composition, is applied at an amount between 0.001 g/ha to 100 g/ha of copper metal. In some embodiments, the combination and/or composition, is applied at an amount between 0.001 g/ha to 50 g/ha of copper metal. In some embodiments, the combination and/or composition, is applied at an amount between 0.001 g/ha to 25 g/ha of copper metal. In some embodiments, the combination and/or composition, is applied at an amount between 0.001 g/ha to 10 g/ha of copper metal.

In some embodiments, the combination and/or composition, is applied at an amount of about 0.0022 g/ha, 0.022 g/ha, 0.22 g/ha, 2.2 g/ha or 22 g/ha of copper metal.

In some embodiments, the combination and/or composition, is applied at an amount of about 0.0075 g/ha, 0.075 g/ha, 0.75 g/ha, 7.5 g/ha or 75 g/ha of copper metal.

In some embodiments, the combination and/or composition, is applied at an amount of about 0.0052 g/ha of copper metal. In some embodiments, the combination and/or composition, is applied at an amount of about 0.001 g/ha of copper metal. In some embodiments, the combination and/or composition, is applied at an amount of about 0.059 g/ha of copper metal. In some embodiments, the combination and/or composition, is applied at an amount of about 0.0095 g/ha of copper metal.

In some embodiments, the combination and/or composition, is applied at an amount of about 15 g/ha of copper metal. In some embodiments, the combination and/or composition, is applied at an amount of about 150 g/ha of copper metal. In some embodiments, the combination and/or composition, is applied at an amount of about 375 g/ha of copper metal. In some embodiments, the combination and/or composition, is applied at an amount of about 450 g/ha of copper metal. In some embodiments, the combination and/or composition, is applied at an amount of about 750 g/ha of copper metal.

A composition and/or combination according to the invention is suitable for the control of pests that are encountered in horticulture, agriculture, and forestry. The compositions are active against normally sensitive and resistant pest species and during all or individual stages of development. Prior to use, a composition comprising a copper-based fungicide and azole fungicide according to the invention is preferably dissolved or dispersed in water, or diluted with water, to provide an aqueous composition comprising between 0.001 and 10 w/v % of the copper-based fungicide. If required, an agriculturally acceptable carrier such as a sticking agent is added to the diluted aqueous composition.

A composition according to the invention is preferably diluted 2-5000 times, preferably about 200 times, with an aqueous solvent, preferably water, to contain between 0.0001 and 10% (w/v) of the copper-based fungicide, prior to contacting a plant, plant part or soil with the composition.

To control agricultural pests, the invention provides a use of a composition comprising a copper-based fungicide and azole fungicide according to the invention for the protection of a plant, or a part of a plant, against a pathogen. In order to achieve this effect, said plant or plant part, or a soil, is contacted with said composition, including a diluted aqueous composition.

Said composition is used, for example, to control soy bean rust, powdery mildew and downy mildew infections on food/feed crops, including tree fruits, vegetable crops, field crops, grapes, ornamental plants, and sod farms. Further use, for example, is to control scab, including common scab, apple scab and black scab on potatoes, pear scab, and powdery scab, brown rot of peaches, currant and gooseberry leaf spot, peanut leafspot, and mildew on roses. Other uses include protection of greenhouse grown flowers and ornamentals, home vegetable gardens and residential turf. In addition, said composition, including a diluted aqueous composition, may be contacted with isolated fruits, nuts, vegetables, and/or flowers.

For said use and said methods, the composition, including a diluted aqueous composition, is preferably sprayed over a plant, or part thereof. Spraying applications using automatic systems are known to reduce labor costs and are cost-effective. Methods and equipment well-known to a person skilled in the art can be used for that purpose. The composition, including diluted aqueous composition, can be regularly sprayed, when the risk of infection is high. When the risk of infection is lower, spray intervals may be longer.

Other methods suitable for contacting plants or parts thereof with a composition of the invention are also a part of the present invention. These include, but are not limited to, dipping, watering, drenching, introduction into a dump tank, vaporizing, atomizing, fogging, fumigating, painting, brushing, misting, dusting, foaming, spreading-on, packaging and coating (e.g. by means of wax or electrostatically). In addition, the composition, including a diluted aqueous composition, may be injected into the soil.

For example, a plant of part thereof may be coated with a diluted aqueous composition comprising a copper-based fungicide according to the invention by submerging the plant or part thereof in a diluted aqueous composition to protect the plant of part thereof against a pathogen and/or to prevent, reduce and/or eliminate the presence of a pathogen on a plant, or a part of a plant. A preferred part of a plant that is coated with a composition according to the invention, or with a dilution thereof, is seed. A further preferred part of a plant that is coated with a composition according to the invention, or with a dilution thereof, is leaf. A further preferred part of a plant that is coated with a composition according to the invention, or with a dilution thereof, is a fruit, preferably a post-harvest fruit such as, for example, a citrus fruit such as orange, mandarin and lime, a pome fruit such as apple and pear, a stone fruit such as almond, apricot, cherry, damson, nectarine, tomato, watermelon, a tropical fruit such as banana, mango, lychee and tangerine. A preferred fruit is a citrus fruit, such as orange and/or a tropical fruit such as banana.

In addition, when lists are provided, the list is to be considered as a disclosure of each member in the list, independently.

Each embodiment disclosed herein is contemplated as being applicable to each of the other disclosed embodiments. Thus, all combinations of the various elements described herein are within the scope of the invention.

This invention will be better understood by reference to the Experimental Details which follow, but those skilled in the art will readily appreciate that the specific experiments detailed are only illustrative of the invention as described more fully in the claims which follow thereafter.

The invention is illustrated by the following examples without limiting it thereby.

### EXPERIMENTAL SECTION

### Example 1

TABLE 1
SE composition of Bordeaux mixture +
Prothioconazole + Picoxystrobin,
with and without compound (I).

| | (SE) without | SE with |
|---|---|---|
| | compound | compound |
| | (I) | (I) |
| Ingredients | % w/w | % w/w |
| Bordeaux Mixture | 34.53 | 34.53 |
| Picoxystrobin | 2.70 | 2.70 |
| Propylene Glycol | 5.00 | 5.00 |
| Geropon T-77 | 2.00 | 2.00 |
| Borresperse CA | 1.00 | 1.00 |
| Atlox Metasperse | 1.00 | 1.00 |
| 500 L | | |
| Atlox 4894 | 3.00 | 3.00 |
| SAG 1572 | 0.10 | 0.10 |
| Proxel GXL | 0.10 | 0.10 |
| Compound (I) | 0.00 | As per |
| (ethylene diamine, | | table 5 |
| thiourea | | |
| or mixture of sodium | | |
| thiosulphate and | | |
| thiourea) | | |
| Prothioconazole | 3.00 | 3.00 |
| Rhodiasolv | 3.00 | 3.00 |
| ADMA 10 | | |
| Emulsogen TS 200 | 1.50 | 1.50 |
| Agrhopol 23 | 0.20 | 0.20 |
| Water | QS | QS |
| | 100.00 | 100.00 |

### Preparation Process

### Sc Preparation:

The required quantity of DM water was taken in the beaker followed by addition of proxel GXL, propylene glycol, Atlox 4894, Borosperse CA, Geropon T77, Metasperse 500L, and ⅓rd part of SAG 1572 with continuous stirring at 350-500 rpm using pitched four blade impeller.

Later Bordeaux mixture is added slowly and mixed well with stirring at 350-500 rpm using pitched four blade impeller until homogeneous slurry is obtained.

then picoxystrobin technical is added slowly and mixed well with stirring at 350-500 rpm using pitched four blade impeller until homogeneous slurry is obtained.

The above premix was grinded in bead mill to attain particle size D90<4 micron

The grinded premix was further stirred at 350-500 rpm using pitched four blade impeller for another 30 minutes after milling.

Compound (I) (ethylene diamine, thiourea or mixture of sodium thiosulphate and thio urea) was dissolved in water and added to the above SC part and mixed well for 5 minutes.

### Preparing the Emulsifiable Concentrate (EC) Comprising Azole Fungicide:

The required quantity of solvent (ADMA10) was taken in a beaker and Prothioconazole technical was added and dissolved.

The emulsifier Emulsogen TS200 was added to the above solution and stirred well at 350-500 rpm using pitched four blade impeller until clear solution is obtained.

### Preparation of Suspoemulsion—SE:

EC part was added slowly for 15-20 min under stirring using pitched four blade impeller at 800-1000 rpm to the SC part prepared earlier.

Increase in viscosity was observed during mixing due to emulsification of EC part with aqueous part of SC.

Stirring was continued for about 30 min and the remaining quantity of SAG 1572 was added. The suspoemulsion obtained was mixed for another 15 minute.

The required quantity of 4% solution of Aghropol 23 was added and stirred well to obtain final suspoemulsion formulation.

### Prothioconazole Measurement Method:

Chromatographic Conditions:

| Column | Agilent Zorbax SB-C18, | |
|---|---|---|
| | 4.6 × 150 mm, 3.5 μm | |
| Flow rate | 0.8 | mL/min |
| Wavelength | 250 | nm |
| Injection Volume | 5 | μL |
| Column Temperature | 30° | C. |
| Run time | 20 | min |

| | |
|---|---|
| Mobile phase (A) | 0.1% Orthophosphoric |
| | acid in water |
| Mobile phase (B) | Acetonitrile |
| Diluent | Acetonitrile |

TABLE 2
Isocratic elution:

| Time (min) | A % | B % |
|---|---|---|
| | 40 | 60 |
| 20 | 40 | 60 |

| | |
|---|---|
| Post run | 5 min |

Blank: Diluent
Standard Solution Preparation:

Weigh accurately about 40 mg of Prothioconazole standard, 40 mg of Picoxystrobin standard into a 100 ml volumetric flask, add few ml diluent, dissolve and then makeup to the mark with diluent. Sonicate for about 5 min. Filter the standard solution with 0.22μ syringe filter.

### Sample Solution Preparation (Duplicate):

Weigh accurately about 1000 mg of sample into a 100 ml volumetric Flask, add 5 ml water, dissolve and then makeup to the mark with diluent. Sonicate for about 5 min. Filter the sample solution with 0.22μ syringe filter.

### Procedure:

Separately inject the equal volumes of standard solution and Sample solution into the chromatographic system. Integrate only Prothioconazole and Picoxystrobin peaks in standard and sample solutions and calculate the separately of Prothioconazole and Picoxystrobin AI content (% w/w) using below calculation formula.

TABLE 3
Injection sequence

| S. No | Sample Name | No of injections |
|---|---|---|
| 1 | Blank (Use diluent) | 1 or until stable |
| | | base line obtained |
| 2 | Standard solution | 3 |
| 3 | Sample solution-1 | 1 |
| 4 | Sample solution-2 | 1 |

TABLE 4
Retention time

| Name of the | Retention time |
|---|---|
| Compound | (±1.0 min) |
| Prothioconazole | 6.70 |
| Picoxystrobin | 9.40 |

$$AI content ( \% w / w ) = \frac{\begin{matrix}( Area of sample ) \times ( Weight of standard ) \times \\ Potency or purity of standard )\end{matrix}}{( \underline{Avg . Area} of standard ) \times ( Weight of sample )} \qquad Calculation$$

TABLE 5
prothioconazole content in the composition.

| | | Metallic | | | | Picoxystrobin, | |
|---|---|---|---|---|---|---|---|
| | | Copper, % wt | | Prothioconazole (% wt) | | % wt | |
| | Compound | 14 day, | 14 day, | 14 day, | 14 day, | 14 day, | 14 day, |
| | (I), % wt | RT | 54° C. | RT | 54° C. | RT | 54° C. |
| Compound | 0% | 9.94 | 7.95 | 2.39 | 2.48 | 2.89 | 2.85 |
| (I) | | | | | | | |
| Ethylene | 2% | 9.55 | 9.56 | 2.81 | 2.82 | 2.67 | 2.65 |
| Diamine | | | | | | | |
| Thio Urea | 0.32% | 9.38 | 9.60 | 3.04 | 2.95 | 2.75 | 2.79 |
| Sodium | 1% + 0.5% | 8.88 | 8.13 | 2.77 | 2.75 | 2.70 | 2.73 |
| Thiosulphate + | | | | | | | |
| Thio Urea | | | | | | | |

### Example 2: (A) SE Composition Comprising Copper Oxychloride, Picoxystrobin and Prothioconazole with Thiourea

TABLE 6

| Ingredient | Chemical name | g/l | w/w % |
|---|---|---|---|
| Copper | dicopper chloride trihydroxide | 293 | 22.89 |
| oxychloride tech | (approximate composition) | | |
| Picoxystrobin | methyl (E)-3-methoxy- | 47 | 3.67 |
| tech | 2-[2-(6-trifluoromethyl- | | |
| | 2-pyridyloxymethyl)phenyl]acrylate | | |
| Prothioconazole | 2-[(2RS)-2-(1-chlorocyclopropyl)-3-(2- | 53 | 4.14 |
| | chlorophenyl)-2-hydroxypropyl]- | | |
| | 2H-1,2,4-triazole-3(4H)-thione | | |
| Acetic Acid | Acetic Acid | 5.8 | 0.45 |
| Acetophenone | Acetophenone | 169.2 | 13.22 |
| AG-RH 23 | Xanthan Gum | 2.6 | 0.2 |
| Agnique BP 420 | Alcohols, C16-18, ethoxylated | 12.8 | 1 |
| Agsolex 8 | propoxylated | 33.8 | 2.64 |
| | (A) 1-octylpyrrolidine-2-one, | | |
| | (B) Octylamine, | | |
| | (C) Dioctylamine, | | |
| | (D) gama-Butyrolactone | | |
| Borresperse CA | (A) Calcium lignosulfonate, (B) Water | 23.9 | 1.87 |
| Chitosan | Poly-b-(1,4)-2amino-2-deoxy-d-glucse | 2.6 | 0.2 |
| Poly Agro A | | 64 | 5 |
| Propylene glycol | 1,2 propanediol | 38.4 | 3 |
| Proxel GXL | (A) 1,2-Benzisothiazol-3(2H)-one, | 0.3 | 0.02 |
| | (B) Sodium hydroxide | | |
| SAG 1572 | Polydimethylsiloxane emulsion | 2.6 | 0.2 |
| sodium acetate | | 32.5 | 2.54 |
| Soprophor TS/16 | Poly(oxy-1,2-ethanediy1), | 25.9 | 2.02 |
| | .alpha.-phenyl-omega.-hydroxy-, | | |
| | styrenated | | |
| Synergen SOC | Poly(oxy(methyl-1,2-ethanediyl)), | 8.5 | 0.66 |
| | .alpha.-hydro-omega.-hydroxy- | | |
| Thiourea | Thiourea, Thiocarbamide, NH2CSNH2 | 4.5 | 0.35 |
| Van Gel B | smectite clay | 3.8 | 0.3 |
| water | water | Up to | Up to |
| | | 1000 L | 100% |

### Material:

PolyAgro A—Poly Agro A is a di-block copolymer, with a total weight of 17000 g/mol, composed of a hydrophobic block (Anchor block-ANCHOR) and a hydrophilic block (Stabilizing block-STAB). The stabilizing, hydrophilic, block is made of sodium 2-Acryloylamino-2-methylpropane-1-sulfonate (AMPS) monomers, which are 77% of the overall monomers in the polymer. The other 23% of the monomers belongs to the anchor, hydrophobic, block which is made of ethyl acrylate monomers. The total amount of monomers in the polymer (degree of polymerization, DPn) is 85 monomers.

This polymer may be obtained according to the following procedure.

### a) Macro CTA

Into a 2L double jacketed reactor equipped with mechanical agitator and reflux condenser was added 11.26 g of O-ethyl-S-(1-methoxycarbonylethyl) xanthate (CH3CH(CO2CH3))S(C═S)OEt), 264.08 g of Ethanol, and 356.32 g of De-ionized water and 1400 g of AMPS (Na) solution (50% active) and 1.52 g of 4,4′-Azobis(4-cyanopentanoic acid). The reactor contents were heated to 70° C. under agitation and nitrogen. The reaction mixture was aged at 70° C. for a further hour whereupon it was cooled to ambient temperature and discharged. The measured solids content was 37.6% (115° C., 60 mins). GPC Mals: Mn=16300 Mw=2600 IP=1.6.

### b) Chain Extension

Into a 5L double jacketed reactor equipped with mechanical agitator and reflux condenser was added 2127 g of macro CTA solution (see a) and 330 g of de-ionized water. The reactor contents were heated to 70° C. under agitation and a nitrogen stream. Once 70° C. was reached, 106.67 g of ethyl acrylate (EA) was added over 2 H 00 and a 37.37 g of a solution of 10 wt % of 4,4′-Azobis(4-cyanopentanoic acid) was concomitantly added over 2 h 30. After the end of the introduction of the initiator solution, the reaction solution was further aged for one hour. Thereafter a shot of 44.85 g of a 10 wt % solution of 4,4′-Azobis(4-cyanopentanoic acid) was added and the mixture aged at 70° C. for a further hour whereupon it was cooled to ambient temperature and discharged. The measured solids content was 40.0% (115° C., 60 mins).

Ethanol was removed from the polymer solution using a rotary evaporator. Water was back added to achieve a polymer solution with a final solids content of 40.4%.

2600 g of polymer solution was placed in a 5L double jacketed reactor equipped with mechanical agitator and reflux condenser. The pH of the solution was increased to 8.5 using a 50% solution of NaOH. The mixture was heated to 70° C. with stirring whereupon 48.4 of a 30% solution of hydrogen peroxide was added in 1 hour. At the end of the additions, the solution was aged for a further 3 h 00 whereupon it was cooled and discharged.

The residuals monomers were measure by HPLC and GC (AMPS=22 ppm, EA=2 ppm).

The measured solids content was 37.5%. The polymer is used in the composition of the present invention as a ready aqua polymer solution at concentration of about 30% w/w.

TABLE 7
PolyAgro A

| | | | | Total | STAB | ANCHOR | | |
|---|---|---|---|---|---|---|---|---|
| AMPS | EA | AMPS | EA | Mnth | Mnth | Mnth | Dpn | Dpn |
| (mol %) | (mol %) | (wt %) | (wt %) | (g/mol) | (g/mol) | (g/mol) | STAB | ANCHOR |
| 77 | 23 | 88 | 12 | 17000 | 15000 | 2000 | 65 | 20 |

### Preparation Process

### Part A:

Mix Acetophenone and Agsolex 8. Add Prothioconazole and Picoxystrobin and mix well until full dissolution.

Add Agnique BP 420, Synergen SOC and Soprophor TS/16 and mix well until full dissolution.

### Part B

Dissolving Acetic acid and Sodium acetate in water. Adding Propylene Glycol and mix.

Add Borreseperse CA and mix. Add Chitosan and mix until full dissolution.

Add SAG 1572 and mix.

Add Polyagro A and mix. Add Cooper Oxychloride tech and mix. Add Thiourea (as a mixture with water (0.35:3) and mix

### Se Preparation:

Add the EC (A) to the water phase (part B) and perform High Shear.

Add the required amount of 10% Van Gel B and 2% AgRH.

(B) SE Composition Comprising Copper Oxychloride, Picoxystrobin and Prothioconazole without Thiourea.

TABLE 8
same procedure as for (A), without adding the thiourea.

| Ingredient | Chemical name | g/l | w/w % |
|---|---|---|---|
| Copper | dicopper chloride trihydroxide | 293 | 22.89 |
| oxychloride tech | (approximate composition) | | |
| Picoxystrobin | methyl (E)-3-methoxy- | 47 | 3.67 |
| tech | 2-[2-(6-trifluoromethyl- | | |
| | 2-pyridyloxymethyl)phenyl]acrylate | | |
| Prothioconazole | 2-[(2RS)-2-(1-chlorocyclopropyl)-3-(2- | 53 | 4.14 |
| | chlorophenyl)-2-hydroxypropyl]- | | |
| | 2H-1,2,4-triazole-3(4H)-thione | | |
| Acetic Acid | Acetic Acid | 5.8 | 0.45 |
| Acetophenone | Acetophenone | 169.2 | 13.22 |
| AG-RH 23 | Xanthan Gum | 2.6 | 0.2 |
| Agnique BP 420 | Alcohols, C16-18, ethoxylated | 12.8 | 1 |
| | propoxylated | | |
| Agsolex 8 | (A) 1-octylpyrrolidine-2-one, | 33.8 | 2.64 |
| | (B) Octylamine, | | |
| | (C) Dioctylamine, | | |
| | (D) gama-Butyrolactone | | |
| Borresperse CA | (A) Calcium lignosulfonate, (B) Water | 23.9 | 1.87 |
| Chitosan | Poly-b-(1,4)-2amino-2-deoxy-d-glucse | 2.6 | 0.2 |
| Poly Agro A | | 64 | 5 |
| Propylene glycol | 1,2 propanediol | 38.4 | 3 |
| Proxel GXL | (A) 1,2-Benzisothiazol-3(2H)-one, | 0.3 | 0.02 |
| | (B) Sodium hydroxide | | |
| SAG 1572 | Polydimethylsiloxane emulsion | 2.6 | 0.2 |
| sodium acetate | | 32.5 | 2.54 |
| Soprophor TS/16 | Poly(oxy-1,2-ethanediy1), | 25.9 | 2.02 |
| | .alpha.-phenyl-omega.-hydroxy-, | | |
| | styrenated | | |
| Synergen SOC | Poly(oxy(methyl-1,2-ethanediyl)), | 8.5 | 0.66 |
| | .alpha.- hydro-omega.-hydroxy- | | |
| Van Gel B | smectite clay | 3.8 | 0.3 |
| water | water | Up to | Up to |
| | | 1000 L | 100% |

### Prothioconazole Amount Measurements:

Assay by HPLC:
1.1 Chromatographic Condition:

| | |
|---|---|
| System: | Agilent 1260 |
| Column: | Agilent, Eclipse Plus C18, 4.6 × 100 mm, |
| | 3.5 μm, Cat No: 959961-902 |
| Mobile Phase: | Line A: Acetonitrile |
| | Line B: 0.1% phosphoric acid in water, v/v |
| | Line C: Methanol |
| | Line A:Line B: Line C, 35%:50%:15% |
| | (Isocratic mode) |
| Stop Time: | 15 min. |
| Flow: | 1.5 ml/min |
| Detector: | DAD; Wavelength set |
| Injection Volume: | 5 μl |
| Column Temperature: | 40° C. |
| Picoxystrobin: | RT about 8.9 min |
| Prothioconazole: | RT about 7.6 min |

### 1.2 Standard Solution Preparation:

Accurately weigh in triplicate about 10 mg of Prothioconazole and about 10 mg of Picoxystrobin standards into a 50 ml volumetric flask, add 10 ml of Acetonitrile and agitate in ultrasonic bath for about 5 minutes. Cool the sample to RT and add Acetonitrile up to the mark.

### 1.3 Sample Solution Preparation:

Accurately weigh in triplicate about 300 mg sample into a 50 ml volumetric flask, add 30 ml Acetonitrile and agitate in ultrasonic bath for about 40 minutes. Cool the sample to RT and add Acetonitrile up to the mark.

### 1.4 Procedure:

Cool down to room temperature and inject Standard and Sample weights.

Bracket sample concentrations with working standard concentrations.

$$\% AI = \frac{{Area}_{Sample} \times {Weight}_{Standard} \times Potency {.}_{Standard}}{{Area}_{Standard} \times {Weight}_{Sample}} \qquad Calculations$$

TABLE 9
prothioconazole content in the
composition after 1 week at 54° C.

| | Composition with | Composition |
|---|---|---|
| | Thiourea | without Thiourea |
| | 1 week at 54° C. | 1 week at 54°C. |
| Prothioconazole | 4 | 3.4 |
| concentration | | |
| (% w/w) | | |

### Example 3: SE Composition of Bordeaux Mixture+ Prothioconazole+ Picoxystrobin

TABLE 10
Composition with Thiourea

| Ingredients | % w/w |
|---|---|
| Bordeaux Mixture | 34.53 |
| Picoxystrobin | 2.70 |
| Glycerol | 10.00 |
| Geropon ® T-77 | 2.00 |
| Atlox Metasperse ™ 500 L | 1.00 |
| ATLAS G5002L | 1.00 |
| SAG 1572 | 0.10 |
| Proxel GXL | 0.02 |
| Prothioconazole | 3.00 |
| Rhodiasolv ® Adma 10 | 3.50 |
| Soprophor BSU | 1.00 |
| Rhodopol AgrhO 23 | 0.20 |
| Thiourea | 0.40 |
| Water | 40.95 |
| | 100.00 |

TABLE 11
Prothioconazole content in the composition.

| | | | Prothioconazole | | | |
|---|---|---|---|---|---|---|
| | Copper, % wt | | (% wt) | | Picoxystrobin, % wt | |
| | 14 day, | 14 day, | 14 day, | 14 day, | 14 day, | 14 day, |
| % wt | RT | 54° C. | RT | 54° C. | RT | 54° C. |
| Thiourea | 8.94 | 8.73 | 3.16 | 3.12 | 2.62 | 2.47 |
| 0.4% | | | | | | |

### Preparation Process of Suspo-Emulsion

### PART (A) SC Slurry/Premix Preparation:

The SC portion premix was by prepared by adding Glycerol, defoamer SAG 1572, Atlas G5002L, Atlox Metasperse 500L, partial amount of water and stirred well. Geropon T-77, are added and continued stirring to avoid any lump formation. Bordeaux mixture was added to slowly, followed by picoxystrobin. This slurry was mixed and stirred for 30 minutes and milled further in the bead mill at temperature less than 25C to obtain particle size less than 7 micron.

### Part (B) EW Preparation:

Prothioconazole Tech was added into required quantity of solvent Adma 10 followed by addition of emulsifier Soprophor BSU to obtain clear EC solution. This EC is further mixed slowly into water containing thiourea and stirred well to obtain white milky homogeneous EW.

### PART (C) Suspoemulsion Preparation:

The EW prepared in previous step is added to the slurry/premix very slowly to obtain mixture which changes from Bluish green→Gray→Bluish green on stirring for 30-45 minutes. This is further homogenized at temperature less than 30C to obtain flowable mixture and required quantity of 2% aqueous rheology modifier, xantham gum was added and stirred for 1 hour to obtain final suspoemulsion formulation

The following statements are intended to describe some elements of the invention.

1. A composition comprising (1) copper-based fungicide, (2) azole fungicide, and (3) compatibility agent.

2. The combination of claim 1, wherein the compatibility agent is compound (I) selected from the group consisting of thiourea-based compound, sodium thiosulfate, alkyl amine, thioamide-based compound, and any combination thereof.

3. The composition of claim 1, wherein:
a) the composition comprises water,
b) the composition comprises at least one agriculturally acceptable additive,
c) the composition further comprises an additional fungicide,
d) the composition is a suspension concentrate or a suspoemulsion, and/or
e) the composition comprises an amount of the azole fungicide that is at least 90% w/w of the amount of azole fungicide used for formulating the composition.

4. (canceled)

5. (canceled)

6. (canceled)

7. (canceled)

8. (canceled)

9. (canceled)

10. The composition of claim 1, wherein:
a) the composition comprises water and the copper-based fungicide and/or the azole fungicide is suspended in the water, and/or
b) the composition comprises a water-immiscible carrier and the azole fungicide is dissolved in the water-immiscible carrier.

11. (canceled)

12. (canceled)

13. (canceled)

14. (canceled)

15. The composition of claim 3, wherein the additional fungicide is selected from the group consisting of strobilurin fungicides, benzamide fungicide, morpholines, QiI fungicide, SDHI and any combinations thereof.

16. (canceled)

17. The composition of claim 15, wherein the additional fungicide comprises picoxystrobin and/or azoxystrobin and/or fluxapyroxad.

18. (canceled)

19. The composition of claim 1, wherein:
a) the copper based fungicide is selected from the group consisting of, cupric acetate, cupric chloride, cupric chlorate, cupric formate, cupric hexafluorosilicate, cupric nitrate, cupric chromate, copper sulfate pentahydrate, bordeaux mixture, copper hydroxide, cuprous oxide, copper oxychloride, copper oxychloride sulfate (COCS), tribasic copper sulfate such as cupric sulfate, tricupric hydroxide, hemihydrate, and any combination thereof, and/or
b) the azole fungicide is selected from the group consisting of, azaconazole; bitertanol; bromuconazole; cyproconazole; difenoconazole; diniconazole; epoxiconazole; etaconazole; fenbuconazole; fluquinconazole; flusilazole; flutriafol; hexaconazole; imibenconazole; ipconazole; metconazole; myclobutanil; penconazole; propiconazole, simeconazole; tebuconazole; tetraconazole; triadimefon; triadimenol; triticonazole; prothioconazole; mefentrifluconazole; and any combinations thereof.

20. The composition of claim 1, wherein:
a) the copper-based fungicide comprises Bordeaux mixture and/or copper oxychloride, and/or
b) the azole fungicide comprises prothioconazole.

21. (canceled)

22. The composition of claim 1, wherein:
a) the concentration of metallic copper in the composition is 0.1% to 10% by weight based on the total weight of the composition, and/or
b) the concentration of the azole fungicide in the composition is between 1% to 10% by weight based on the total weight of the composition.

23. (canceled)

24. (canceled)

25. (canceled)

26. The composition of claim 2, wherein:
a) the concentration of the compound (I) in the composition is between 0.01% to 10% by weight based on the total weight of the composition, and/or
b) the compound (I) is a thiourea-based compound having a structure defined by the following formula:
R¹NH—C(═S)—NHR²
wherein,
(i) R¹, R², are both H;
(ii) R¹ is H and R² is alkyl or alkenyl or alkynyl or aryl or heterocyclic;
(iii) R¹, R² are each, independently, alkyl, alkenyl or alkynyl;
(iv) R¹, R² are each, independently, aryl, or heterocyclic;
(v) R¹ is alkyl or alkenyl or alkynyl and R² is aryl or heterocyclic, or
R¹ and R² can be taken together with the nitrogens to which they are attached to form a ring containing 2 to 4 atoms of carbon and optionally one additional atom of nitrogen, sulfur or oxygen, said ring may be saturated or unsaturated and optionally substituted with 1 to 4 substituents selected from the group consisting of C₁-C₂ alkyl, halogen, CN, NO₂ and C₁-C₂ alkoxy.

27. The composition of claim 2, wherein:
a) the concentration of the thiourea-based compound in the composition is between 0.1% to 5% by weight based on the total weight of the composition,
b) the concentration of the sodium thiosulfate in the composition is between 1% to 5% by weight based on the total weight of the composition,
c) the concentration of the alkylamine in the composition is between 0.5% to 8% by weight based on the total weight of the composition, and/or
d) the concentration of the thioamide-based compound in the composition is between 0.1% to 5% by weight based on the total weight of the composition.

28. (canceled)

29. The composition of claim 2, wherein the compound (I) is thiourea having the structure, H₂N—C(═S)—NH₂.

30. (canceled)

31. (canceled)

32. The composition of claim 1, wherein:
a) the composition comprises (1) a copper-based fungicide, (2) picoxystrobin, (3) water, (4) prothioconazole, (5) a water-immiscible carrier, and (6) compound (I) selected from the group consisting of thiourea-based compound, hexamethylene tetra amine, sodium thiosulfate, ethylene diamine and any combinations thereof, wherein the picoxystrobin is suspended in the water and the prothioconazole is dissolved in the water-immiscible carrier, or
b) the composition comprises (1) copper-based fungicide, (2) prothioconazole, (3) picoxystrobin, (4) water, and (5) compound (I) selected from the group consisting of thiourea-based compound, hexamethylene tetra amine, sodium thiosulfate, ethylene diamine and any combinations thereof, wherein the prothioconazole and the picoxystrobin are suspended in the water.

33. (canceled)

34. A method for preventing and/or reducing the rate and/or extent of reduction of the amount of azole fungicide in a composition which comprises copper-based fungicide and the azole fungicide, the method comprising including a compound (I) selected from the group consisting of thiourea-based compound, hexamethylene tetra amine, sodium thiosulfate, ethylene diamine and any combinations thereof in the composition.

35. The method of claim 34, wherein:
a) the compound (I) is added before adding the azole fungicide to the composition, or wherein compound (I) is added no later than 30 minutes after the addition of the last of the azole fungicide and the copper-based fungicide to the composition,
b) the copper-based fungicide is selected from group consisting of cupric acetate, cupric chloride, cupric chlorate, cupric formate, cupric hexafluorosilicate, cupric nitrate, cupric chromate, copper sulfate pentahydrate, bordeaux mixture, copper hydroxide, cuprous oxide, copper oxychloride, copper oxychloride sulfate (COCS), tribasic copper sulfate such as cupric sulfate, tricupric hydroxide, hemihydrate, and any combination thereof, and/or
c) the azole fungicide is prothioconazole.

36. (canceled)

37. (canceled)

38. (canceled)

39. (canceled)

40. (canceled)

41. A process for producing the composition of claim 2 wherein the compatibility agent is compound (I) selected from group consisting of thiourea-based compound, hexamethylene tetra amine, sodium thiosulfate, ethylene diamine and any combination thereof, wherein the process comprises the following steps: (a) preparing an aqueous composition of the copper-based fungicide and the compound (I), and (b) mixing the aqueous composition with the azole fungicide.

42. (canceled)

43. A method for maintaining at least 90% w/w of the amount of the azole fungicide which was used for formulating a composition comprising formulating the azole fungicide in the composition of claim 1.

44. A combination comprising (1) copper-based fungicide, (2) azole fungicide, and (3) compatibility agent.

45. (canceled)

46. The composition of claim 1, wherein the composition comprises an anionic dispersant.

47. The composition of claim 46, wherein the anionic dispersant is sodium methyl oleyl taurate.
